(19) United States
(12) Patent Application Publication
(10) Pub. No.: US 2014/0144998 A1
(43) Pub. Date: May 29, 2014

(54) AIR CONDITIONER FOR VEHICLE

(71) Applicants: Yoshinori Ichishi, Kariya-city (JP); Tetsuya Takechi, Handa-city (JP); Yoshinori Kumamoto, Takahama-city (JP); Hidekazu Hirabayashi, Chiryu-city (JP); Yoshihisa Shimada, Nagoya-city (JP)

(72) Inventors: Yoshinori Ichishi, Kariya-city (JP); Tetsuya Takechi, Handa-city (JP); Yoshinori Kumamoto, Takahama-city (JP); Hidekazu Hirabayashi, Chiryu-city (JP); Yoshihisa Shimada, Nagoya-city (JP)

(73) Assignee: TOYOTA JIDOSHA KABUSHIKI KAISHA, Aichi-ken (JP)

(21) Appl. No.: 14/234,813

(22) PCT Filed: Jul. 3, 2012
(86) PCT No.: PCT/JP2012/066977

§ 371 Date: Jan. 24, 2014

(30) Foreign Application Priority Data
Jul. 28, 2011 (JP) 2011-165444

(51) Int. Cl. B60H 1/04

(52) U.S. Cl. CPC B60H 1/04
USPC 237/12.3 A

(57) ABSTRACT

An air conditioner for a vehicle having an electric motor for traveling and an internal combustion engine as driving sources for outputting a driving force for causing the vehicle to travel, the air conditioner including: a heating section that heats blown air to be blown into a vehicle interior by using a coolant of the internal combustion engine as a heat source; a request signal output section that outputs a request signal to a driving force control section in heating the vehicle interior, the driving force control section controlling an operation of the internal combustion engine, the request signal causing the internal combustion engine to operate until a temperature of the coolant reaches an upper limit temperature; and a suppression section for suppressing output of the request signal from the request signal output section until a predetermined condition is satisfied after startup of the vehicle.

### TECHNICAL FIELD

The present invention relates to an air conditioner for a vehicle that heats air in the interior of the vehicle by using waste heat from an engine.

### BACKGROUND ART

Hybrid cars are conventionally known which can obtain a driving force for traveling from both an engine (internal combustion engine) and an electric motor for traveling. PTL 1 discloses an air conditioner for a vehicle that is applied to such a hybrid car. The air conditioner for the vehicle disclosed in PTL 1 is designed to heat blown air to be blown into a vehicle interior by use of a coolant of the engine as a heat source in heating the vehicle interior.

Such hybrid cars often stop the engine even in stopping or traveling of the car so as to improve fuel efficiency. For this reason, when the air conditioner is intended to heat the vehicle interior, the coolant does not sometimes reach a sufficient temperature to serve as a heat source for heating.

In the air conditioner for the vehicle disclosed in PTL 1, even under traveling conditions that do not require the operation of the engine to output the driving force for traveling, a request signal for operation of the engine is output to a driving force controller when the coolant does not reach the sufficient temperature to serve as the heat source for heating. Then, the temperature of the coolant is increased up to the sufficient temperature as the heat source for heating.

### CITATION LIST

### Patent Literature

### PTL 1

Japanese Patent Publication No. 4321594

### SUMMARY OF INVENTION

### Technical Problem

Recently, the hybrid cars called “plug-in hybrid car” can charge a battery mounted on a vehicle with power from an external power source (commercial power source) during stopping of the vehicle.

This kind of plug-in hybrid car is designed to travel in an EV operation mode for obtaining a driving force for traveling mainly from the electric motor for traveling when a remaining storage level (i.e. remaining electric storage level) of the battery is equal to or more than a prescribed reference remaining level for traveling upon startup or the like by previously charging the battery with power from the external power source during stopping. On the other hand, the plug-in hybrid car is also designed to travel in an HV operation mode for obtaining a driving force for traveling mainly from the engine when a remaining storage level of the battery is lower than the reference remaining level for traveling.

When the air conditioner for the vehicle disclosed in PTL 1 is applied to the plug-in hybrid car and the engine is operated to increase the temperature of the coolant up to the sufficient temperature as the heat source for heating in the EV operation mode, the engine is frequently actuated even under the EV operation mode, which can make a passenger feel uncomfortable.

When the engine is actuated with the battery substantially fully charged at startup or the like, the passenger might feel very uncomfortable, which makes it difficult to use the charged power for traveling, disadvantageously reducing the fuel efficiency of the vehicle.

In view of the foregoing points, it is an object of the present invention to suppress the operation of an internal combustion engine for increasing the temperature of coolant at startup in an air conditioner for a vehicle to be applied to a hybrid car.

### Solution to Problem

In order to achieve the above object, an air conditioner for a vehicle which is applied to the vehicle having an electric motor for traveling and an internal combustion engine as driving sources for outputting a driving force for causing the vehicle to travel, the air conditioner comprising: a heating section that heats blown air to be blown into a vehicle interior by using a coolant of the internal combustion engine as a heat source; a request signal output section that outputs a request signal to a driving force control section in heating the vehicle interior, the driving force control section controlling an operation of the internal combustion engine, the request signal causing the internal combustion engine to operate until a temperature of the coolant reaches an upper limit temperature; and a suppression section for suppressing output of the request signal from the request signal output section until a predetermined condition is satisfied after startup of the vehicle.

This arrangement can prevent the request signal for operating the internal combustion engine from being output to the driving force control section until the predetermined condition is satisfied after startup of the vehicle. That is, the air conditioner for the vehicle can suppress the operation of the internal combustion engine that might increase the coolant temperature at the startup of the vehicle.

In a second aspect of the invention according to the first aspect, the air conditioner for the vehicle further includes a time determination section for determining a predetermined time, in which the predetermined condition includes a condition where the predetermined time has elapsed since the startup of the vehicle.

This arrangement can prevent the request signal for operating the internal combustion engine from being output to the driving force control section until the predetermined time has elapsed since the startup of the vehicle. Thus, the air conditioner for the vehicle can surely suppress the operation of the internal combustion engine for increasing the coolant temperature at the startup of the vehicle.

In a third aspect of the invention according to the second aspect, the air conditioner for the vehicle further includes a target temperature setting section that sets a target temperature of the vehicle interior based on an operation of a passenger. As the target temperature becomes higher, the time determination section vmakes the predetermined time shorter.

That is, as the target temperature of the vehicle interior is set higher, the air conditioner for the vehicle can be adapted not to suppress the operation of the internal combustion engine for increasing the coolant temperature at the startup of the vehicle. Thus, the air conditioner can exhibit its heating capacity according to the passenger's request at the startup, and thus can prevent the loss of warmth to the passenger.

In a fourth aspect of the invention according to the second or third aspect, the air conditioner for the vehicle further includes a power saving request section that outputs a power saving request signal based on the passenger's operation, the power saving request signal being for requesting saving of power necessary for air conditioning of the vehicle interior. When the power saving request signal is output, the time determination section makes the predetermined time longer as compared to when the power saving request signal is not output.

Thus, when the power saving is required, the operation of the internal combustion engine for increasing the coolant temperature can be suppressed. Since the power saving is requested by the passenger, the air conditioner cannot make the passenger uncomfortable at all even though a heating capacity is slightly reduced by suppression of the operation of the internal combustion engine.

In a fifth aspect of the invention according to any one of the second to fourth aspects, the air conditioner for the vehicle further includes an auxiliary heating section for increasing a temperature of at least a part of the vehicle interior. When the auxiliary heating section is operating, the time determination section makes the predetermined time longer as compared to when the auxiliary heating section is not operating.

Thus, when the auxiliary heating section is operating, the air conditioner for the vehicle can suppress the operation of the internal combustion engine for increasing the coolant temperature at the startup of the vehicle. Further, when the auxiliary heating section is operating, the air conditioner for the vehicle can make the passenger feel sufficiently warm even though the temperature of air blown into the vehicle interior is low. Thus, the air conditioner for the vehicle can suppress the operation of the internal combustion engine for increasing the coolant temperature at startup of the vehicle without removing the warmth from the passenger.

In a sixth aspect of the invention according to any one of the second to fifth aspects, the air conditioner for the vehicle further includes a vehicle-interior temperature detection section for detecting a temperature of the vehicle interior. As the temperature of the vehicle interior becomes higher, the time determination section makes the predetermined time longer.

Thus, as the vehicle interior air temperature becomes higher, the air conditioner for the vehicle can more effectively suppress the operation of the internal combustion engine for increasing the coolant temperature at the startup of the vehicle. When the required heating capacity is small, the operation of the internal combustion engine for increasing the coolant temperature at the startup of the vehicle can be suppressed more effectively.

In a seventh aspect of the invention according to any one of the second to sixth aspects, the air conditioner for the vehicle further includes a solar radiation amount detection section for detecting a solar radiation amount at the vehicle interior. As the solar radiation amount becomes more, the time determination section makes the predetermined time longer.

Thus, as the solar radiation amount becomes more, the air conditioner for the vehicle can suppress the operation of the internal combustion engine for increasing the coolant temperature at the startup of the vehicle. When the required heating capacity is small, the operation of the internal combustion engine for increasing the coolant temperature can be suppressed effectively at the startup of the vehicle.

In an eighth aspect of the invention according to any one of the second to seventh aspects, the air conditioner for the vehicle further includes an outside air temperature detection section for detecting an outside air temperature. As the outside air temperature becomes higher, the time determination section makes the predetermined time longer.

Thus, as the outside air temperature becomes higher, the air conditioner for the vehicle can more effectively suppress the operation of the internal combustion engine for increasing the coolant temperature at the startup of the vehicle. When the required heating capacity is small, the operation of the internal combustion engine for increasing the coolant temperature at the startup of the vehicle can be suppressed effectively.

In a ninth aspect of the invention according to any one of the second to eighth aspects, the air conditioner for the vehicle further includes a humidity detection section that detects a relative humidity of air in the vehicle interior. As the relative humidity of the air in the vehicle interior becomes lower, the time determination section makes the predetermined time longer.

Thus, as the relative humidity of the vehicle interior air becomes lower, the air conditioner for the vehicle can suppress the operation of the internal combustion engine for increasing the coolant temperature at the startup of the vehicle. When the fogging is unlikely to be caused on the windshield and the necessity of blowing the warm air toward the windshield is eliminated, the operation of the internal combustion engine for increasing the coolant temperature can be effectively suppressed at the startup of the vehicle.

In a tenth aspect of the invention according to any one of the second to ninth aspects, as a remaining storage level of a battery becomes higher, the time determination section makes the predetermined time longer.

Thus, as the remaining storage level of the battery becomes higher, the air conditioner for the vehicle can suppress the operation of the internal combustion engine for increasing the coolant temperature at the startup of the vehicle. Thus, the charged power can be more easily used for traveling at the startup, which can improve the fuel efficiency of the vehicle.

In an eleventh aspect of the invention according to one of the second to tenth aspects of the invention, the air conditioner further includes a time setting section that sets a time based on a passenger's operation. As the time set by the time setting section becomes longer, the time determination section makes the predetermined time longer.

Thus, as the time set by the passenger's operation becomes longer, the air conditioner for the vehicle can suppress the operation of the internal combustion engine for increasing the coolant temperature at the startup of the vehicle. The air conditioner for the vehicle can surely suppress the operation of the internal combustion engine for increasing the coolant temperature at the startup of the vehicle as desired by the passenger.

In a twelfth aspect of the invention according to any one of the first to eleventh aspects, the air conditioner for the vehicle further includes an upper limit temperature determination section for determining the upper limit temperature. Until the predetermined condition is satisfied after the startup of the vehicle, the upper limit temperature determination section lowers the upper limit temperature as compared to when or after the predetermined condition is satisfied.

This arrangement can prevent the request signal for operating the internal combustion engine from being output to the driving force control section until the predetermined condition is satisfied after startup of the vehicle. That is, the air conditioner for the vehicle can suppress the operation of the internal combustion engine for increasing the coolant temperature at the startup of the vehicle.

Reference numerals in parentheses corresponding to respective section described in the specification and claims indicate the relationship with specific section described in embodiments below.

### BRIEF DESCRIPTION OF DRAWINGS

FIG. 1 is an entire configuration diagram of an air conditioner for a vehicle according to a first embodiment of the invention;

FIG. 2 is a block diagram showing an electric controller of the air conditioner for the vehicle in the first embodiment;

FIG. 3 is a circuit diagram of a PTC heater in the first embodiment;

FIG. 4 is a flowchart showing a control process of the air conditioner for the vehicle in the first embodiment;

FIG. 5 is a flowchart showing a main part of the control process of the air conditioner for the vehicle in the first embodiment;

FIG. 6 is a flowchart showing another main part of the control process of the air conditioner for the vehicle in the first embodiment;

FIG. 7 is a flowchart showing another main part of the control process of the air conditioner for the vehicle in the first embodiment;

FIG. 8 is a flowchart showing another main part of the control process of the air conditioner for the vehicle in the first embodiment;

FIG. 9 is a flowchart showing another main part of the control process of the air conditioner for the vehicle in the first embodiment;

FIG. 10 is a table showing the determination of an operation mode in the first embodiment;

FIG. 11 is a flowchart showing another main part of the control process of the air conditioner for the vehicle in the first embodiment;

FIG. 12 is a flowchart showing a main part of a control process of the air conditioner for the vehicle according to a second embodiment;

FIG. 13 is a flowchart showing a main part of a control process of the air conditioner for the vehicle according to a third embodiment;

FIG. 14 is a flowchart showing another main part of the control process of the air conditioner for the vehicle in the third embodiment;

FIG. 15 is a flowchart showing a main part of a control process of the air conditioner for the vehicle according to a fourth embodiment;

FIG. 16 is a flowchart showing a main part of a control process of the air conditioner for the vehicle according to a fifth embodiment;

FIG. 17 is a flowchart showing a main part of a control process of the air conditioner for the vehicle according to a sixth embodiment;

FIG. 18 is a flowchart showing another main part of the control process of the air conditioner for the vehicle in the sixth embodiment; and

FIG. 19 is a flowchart showing a main part of a control process of the air conditioner for the vehicle according to a seventh embodiment.

### DESCRIPTION OF EMBODIMENTS

### First Embodiment

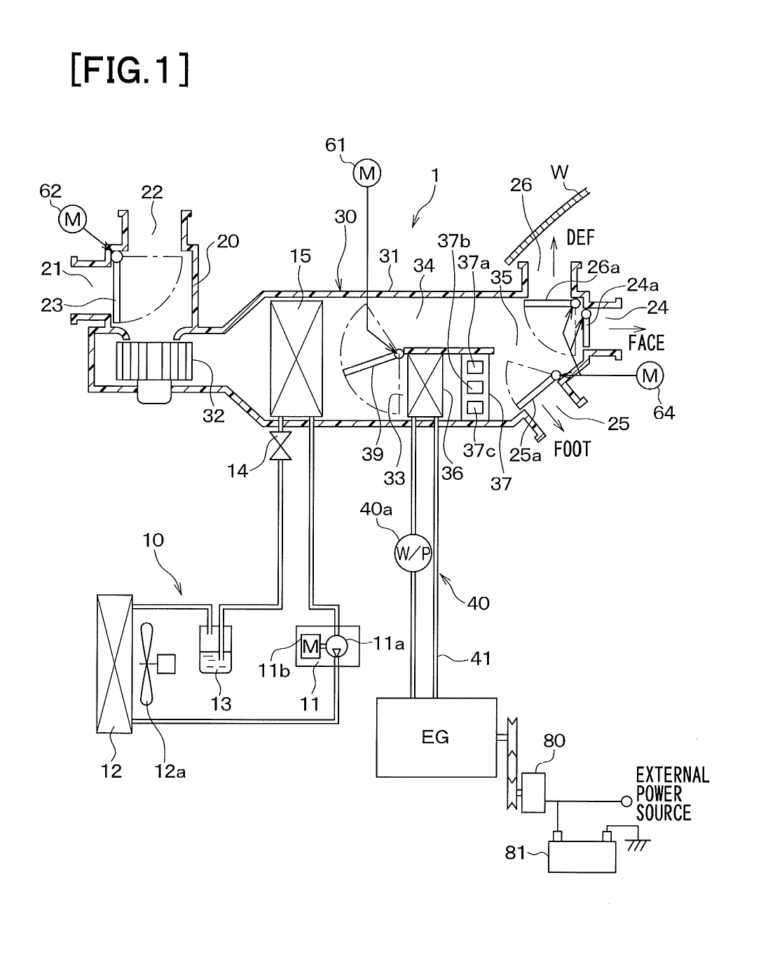

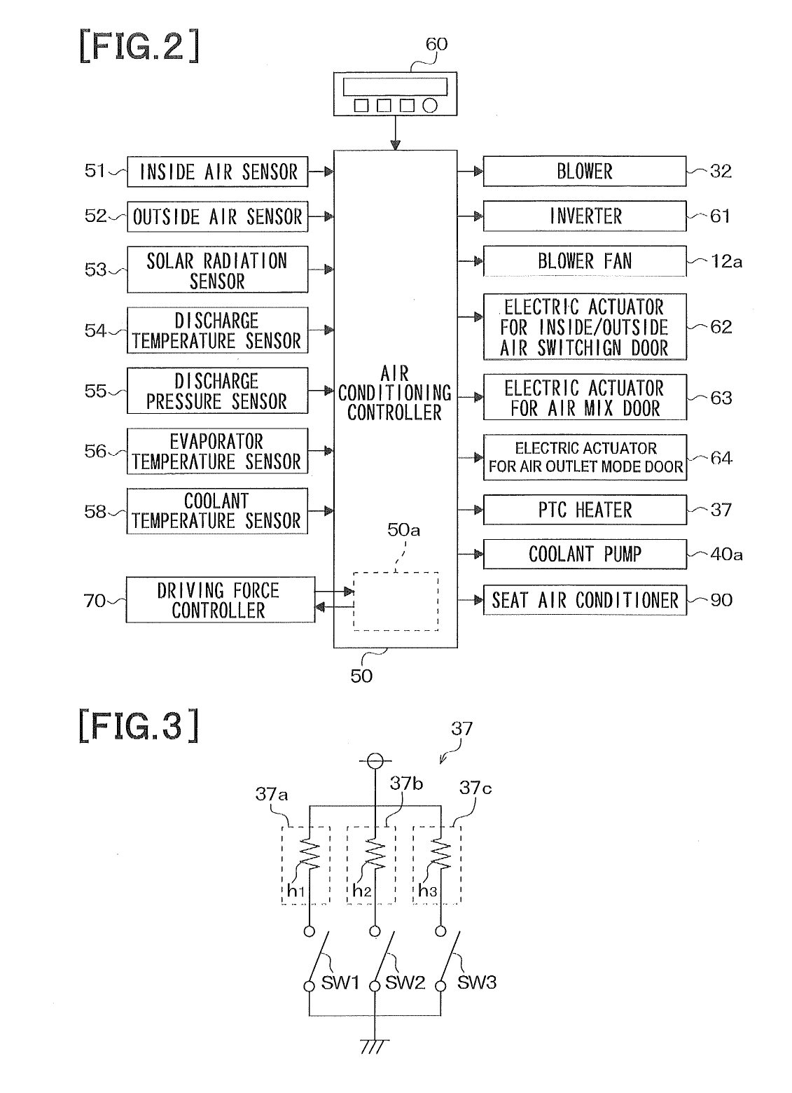

Hereinafter, a first embodiment of the invention will be described below with reference to the accompanying drawings. FIG. 1 shows an entire configuration diagram of an air conditioner 1 for a vehicle according to this embodiment. FIG. 2 shows a block diagram of an electric controller of the air conditioner 1. In this embodiment, the air conditioner 1 is applied to a hybrid car that can obtain the driving force for traveling from both an internal combustion engine (engine) EG and an electric motor for traveling.

The hybrid ear of this embodiment is configured as a plug-in hybrid car that can charge a battery 81 with power supplied from an external power source (commercial power source) during stopping of the vehicle.

The plug-in hybrid car previously charges the battery 81 with power from the external power source while the vehicle is stopping before startup. When the remaining storage level (i.e. remaining electric storage level) SOC of the battery 81 is equal to or more than a prescribed reference remaining level for traveling, for example, at the startup of the vehicle, the vehicle is brought into an operation mode in which the vehicle travels by the driving force given mainly from the electric motor for traveling. This operation mode is hereinafter referred to as an “EV operation mode”.

On the other hand, when the remaining storage level SOC of the battery 81 is lower than the reference remaining level for traveling while the vehicle is traveling, the plug-in hybrid car is also brought into another operation mode in which the vehicle travels by the driving force generated mainly from the internal combustion engine EG. This operation mode is hereinafter referred to as an “HV operation mode”.

More specifically, the EV operation mode is an operation mode in which the vehicle is traveling by the driving force output mainly from the electric motor for traveling. The EV operation mode assists in the electric motor for traveling by operating the internal combustion engine EG when a load on traveling of the vehicle becomes high. That is, the EV operation mode is the operation mode in which the driving force for traveling (motor-side driving force) output from the electric motor for traveling is larger than the driving force (internal combustion engine side driving force) output from the internal combustion engine EG.

In other words, the EV operation mode can be represented by the operation mode in which a ratio of the motor-side driving force to the internal combustion engine side driving force (motor side driving force/internal combustion engine side driving force) is larger than at least 0.5.

In contrast, the HV operation mode is an operation mode in which the vehicle is traveling by the driving force output mainly from the internal combustion engine EG. If the load on traveling vehicle becomes high, the electric motor for traveling can be operated to assist the internal combustion engine EG. That is, the HV operation mode is an operation mode in which the internal combustion engine side driving force is larger than the motor-side driving force. In other words, the HV operation mode can be defined as the operation mode in which the driving force ratio (motor-side driving force/internal combustion engine-side driving force) is smaller than at least 0.5.

The plug-in hybrid car of this embodiment performs switching between the EV operation mode and the HV operation mode in this way to thereby suppress the consumption of fuel of the internal combustion engine EG to improve the fuel efficiency of the vehicle as compared to the normal vehicles that can obtain the driving force for traveling only from the internal combustion engine EG. Such switching between the EV operation mode and the HV operation mode, and the control of the driving force ratio are controlled by a driving force controller 70 to be described later.

The driving force output from the internal combustion engine EG is used not only for traveling of the vehicle, but also for operating a generator 80. Power generated by the generator 80 and power supplied from the external power source can be stored in the battery 81. The power stored in the battery 81 can be supplied not only to the electric motor for traveling, but also to various vehicle-mounted devices, including an electric component constituting the air conditioner 1 for the vehicle.

Next, the detailed structure of the air conditioner 1 for the vehicle in this embodiment will be described below. The air conditioner 1 of this embodiment includes a refrigeration cycle 10 shown in FIG. 1, an indoor air conditioning unit 30, an air conditioning controller 50 shown in FIG. 2, a sheet air conditioner 90, and the like. The indoor air conditioning unit 30 is first disposed inside a dashboard (instrument panel) at the forefront of a vehicle compartment, and accommodates in a casing 31 forming its outer envelope, a blower 32, an evaporator 15, a heater core 36, a PTC heater 37, and the like.

The casing 31 forms an air passage for blown air to be blown into the vehicle interior. The casing 31 is formed of resin (for example, polypropylene) having some elasticity and excellent strength. On the most upstream side of the blown air flow in the casing 31, an inside/outside air switching box 20 is provided to serve as an inside/outside air switching means for switching between inside air (air in the vehicle interior) and outside air (air outside the vehicle interior) and introducing the air selected.

More specifically, the inside/outside air switching box 20 is provided with an inside air introduction port 21 for introducing the inside air into the casing 31, and an outside air introduction port 22 for introducing the outside air into the casing 31. Inside the inside/outside air switching box 20, an inside/outside switching door 23 is provided to change the ratio of the volume of the inside air to that of the outside air to be introduced into the casing 31 by continuously adjusting respective opening areas of the inside air introduction port 21 and the outside air introduction port 22.

Thus, the inside/outside air switching door 23 serves as an air volume ratio changing means for switching between suction port modes to change the ratio of the volume of inside air to that of outside air introduced into the casing 31. More specifically, the inside/outside air switching door 23 is driven by an electric actuator 62 for the inside/outside switching door 23. The electric actuator 62 has its operation controlled by a control signal output from an air conditioning controller 50 to be described later.

The suction port modes include an inside air mode for introducing the inside air into the casing 31 by fully opening the inside air introduction port 21 and completely closing the outside air introduction port 22; an outside air mode for introducing the outside air into the casing 31 by completely closing the inside air introduction port 21 and fully opening the outside air introduction port 22; and an inside/outside air mixing mode set between the inside air mode and the outside air mode, for continuously changing the ratio of introduction the inside air to the outside air by continuously adjusting the respective opening areas of the inside air introduction port 21 and the outside air introduction port 22.

On the downstream side of the air flow in the inside/outside air switching box 20, the air blower (blower) 32 is provided to serve as a blowing means for blowing air sucked via the inside/outside air switching box 20 into the vehicle interior. The blower 32 is an electric blower that drives a centrifugal multi-blade fan (scirocco fan) by an electric motor. The blower 32 has its number of revolutions (volume of blown air) controlled by a control voltage output from the air conditioning controller 50. Thus, the electric motor serves as a blowing capacity changing means included in the blower 32.

On the downstream side of the air flow from the blower 32, an evaporator 15 is disposed. The evaporator 15 serves as a heat exchanger for cooling that exchanging heat between the refrigerant flowing therethrough, and the blown air blown from the blower 32 to thereby cool the blown air. Specifically, the evaporator 15 forms a vapor compression refrigeration cycle 10 together with a compressor 11, a condenser 12, a gas-liquid separator 13, and an expansion valve 14.

The compressor 11 is positioned in an engine room, and is to suck, compress, and discharge the refrigerant in the refrigeration cycle 10. The compressor is an electric compressor which drives a fixed displacement compressor 11a having a fixed discharge capacity by use of an electric motor 11b. The electric motor 11b is an AC motor whose operation (number of revolutions) is controlled by an AC voltage output from an inverter 61.

The inverter 61 outputs an AC voltage at a frequency corresponding to a control signal output from the air conditioning controller 50 to be described later. The refrigerant discharge capacity of the compressor 11 is changed by the control of the number of revolutions of the motor. Thus, the electric motor 11b serves as a discharge capacity changing means of the compressor 11.

The condenser 12 is an outdoor heat exchanger disposed in the engine room, and which serves to condense the refrigerant discharged from the compressor 11 by heat exchange between the refrigerant flowing therethrough and the outdoor air (outside air) blown from a blower fan 12a as an outdoor blower. The blower fan 12a is an electric blower whose operating ratio or number of revolutions (volume of blown air) is controlled by a control voltage output from the air conditioning controller 50.

The gas-liquid separator 13 is a receiver that separates the refrigerant condensed by the condenser 12 into gas and liquid phases with the excessive refrigerant stored therein to thereby allow only the liquid-phase refrigerant to flow to the downstream side. The expansion valve 14 is a decompression means for decompressing and expanding the liquid-phase refrigerant flowing from the gas-liquid separator 13. The evaporator 15 is an indoor heat exchanger for evaporating the refrigerant decompressed and expanded by the expansion valve 14 to exhibit a heat absorption effect in the refrigerant. Thus, the evaporator 15 serves as a heat exchanger for cooling that cools the blown air.

On the downstream side of the air flow of the evaporator 15 within the casing 31, there are provided air passages for flowing the air passing through the evaporator 15, including a cool air passage 33 for heating and a cool air bypass passage 34, and a mixing space 35 for mixing air flowing from the cool air passage 33 for heating with air flowing from the cool air bypass passage 34.

The heater core 36 and the PTC heater 37 for heating the air having passed through the evaporator 15 are arranged in that order along the direction of the flow of the blown air in the cool air passage 33 for heating. The heater core 36 is a heat exchanger for heating that exchanges heat between the blown air having passed through the evaporator 15 and an engine coolant (hereinafter referred to as a single “coolant”) for cooling an engine EG to thereby heat the blown air having passed through the evaporator 15.

Specifically, the heater core 36 and the engine EG are connected together by coolant pipes to form a coolant circuit 40 for allowing the coolant to circulate through between the heater core 36 and the internal combustion engine EG. The coolant circuit 40 is provided with a coolant pump 40a for circulating the coolant. The coolant pump 40a is an electric water pump whose number of revolutions (flow rate of circulating coolant) is controlled by a control voltage output from the air conditioning controller 50.

The PTC heater is an electric heater with a PTC element (positive characteristic thermistor), and serving as auxiliary heater for heating air having passed through the heater core 36 with heat generated by supplying power to the PTC element. The power consumption required to operate the PTC heater 37 in this embodiment is smaller than that required to operate the compressor 11 of the refrigerant cycle 10.

More specifically, as shown in FIG. 3, the PTC heaters 37 include a plurality of (three in this embodiment) PTC heaters 37a, 37b, and 37c. FIG. 3 shows a circuit diagram of the electric connection of the PTC heaters 37 in this embodiment.

As shown in FIG. 3, the PTC heaters 37a, 37b, and 37c have positive electrodes thereof connected to the battery 81 sides, and negative electrodes thereof connected to the ground via respective switching elements SW1, SW2, and SW3 included in the PTC heaters 37a, 37h, and 37c. The switching elements SW1, SW2, and SW3 switch PTC elements h1, h2, and h3 included in the PTC heaters 37a, 37b, and 37c between an energization (ON) state and a non-energization (OFF) state.

The operations of the switching elements SW1, SW2, and SW3 are independently controlled by control signals output from the air conditioning controller 50. Thus, the air conditioning controller 50 independently switches the switching elements SW1, SW2, and SW3 between the energization state and the non-energization state to perform switching among the PTC heaters 37a, 37b, and 37c to exhibit the heating capacity of the corresponding PTC heater in the energization state, and thereby changing the heating capacity of the entire PTC heater 37.

On the other hand, the cool air bypass passage 34 is an air passage for guiding air having passed through the evaporator 15 to the mixing space 35 without allowing the air to pass through the heater core 36 and the PTC heater 37. Thus, the temperature of blown air mixed in the mixing space 35 is changed depending on the ratio of the volume of air passing through the cool air passage 33 for heating to that of air passing through the cool air bypass passage 34.

In this embodiment, an air mix door 39 is disposed on the downstream side of the air flow of the evaporator 15, and on inlet sides of the cool air passage 33 for heating and the cool air bypass passage 34. The air mix door 39 continuously changes the ratio of the volume of cool air flowing into the cool air passage 33 for heating to that of the air into the bypass passage 34. Thus, the air mix door 39 serves as a temperature adjustment means for adjusting the temperature of air in the mixing space 35 (or the temperature of blown air to be blown into the vehicle interior).

More specifically, the air mix door 39 is the so-called cantilever door, which includes a rotary shaft driven by an electric actuator 63 for the air mix door, and a plate-like door main body having its one end coupled to the rotary shaft. The electric actuator 63 for the air mix door has its operation controlled by a control signal output from the air conditioning controller 50.

On the most downstream side of the blown air flow of the casing 31, air outlets 24 to 26 are disposed to send out the blown air whose temperature is adjusted, from the mixing space 35 into the vehicle compartment as a space of interest for air conditioning. Specifically, the air outlets 24 to 26 include a face air outlet 24 for blowing the conditioned air toward the upper body of a passenger in the vehicle compartment, a foot air outlet 25 for blowing the conditioned air toward the foot of the passenger, and a defroster air outlet 26 for blowing the conditioned air toward the inner side of a front glass of the vehicle.

The face air outlet 24, foot air outlet 25, and defroster air outlet 26 have, at the respective upstream sides of the air flows thereof, a face door 24a for adjusting an opening area of the face air outlet 24, a foot door 25a for adjusting an opening area of the foot air outlet 25, and a defroster door 26a for adjusting an opening area of the defroster air outlet 26.

The face door 24a, foot door 25a, and defroster door 26a serve as an air outlet mode switching means for switching among air outlet modes. These doors are coupled to and rotated by the electric actuator 64 for driving an air outlet mode door via a link mechanism (not shown). The electric actuator also has its operation controlled by a control signal output from the air conditioning controller 50.

The air outlet modes include a face mode for blowing out air from the face air outlet 24 toward the upper body of the passenger in the vehicle compartment by fully opening the face air outlet 24, and a bi-level mode for blowing out air toward the upper body and foot of the passenger in the vehicle compartment by fully opening both the face air outlet 24 and the foot air outlet 25. The air outlet modes also include a foot mode for blowing out air mainly from the foot air outlet 25 by fully opening the foot air outlet 25 and slightly opening the defroster air outlet, and a foot/defroster mode for blowing out air from both foot air outlet 25 and defroster air outlet 26 by opening the foot air outlet 25 and the defroster air outlet 26 to the same degree.

A switch of an operation panel 60 to be described later can also be manually operated by the passenger to fully open the defroster air outlet, thereby bringing the air conditioner into the defroster mode for blowing out the air from the defroster air outlet into the inner surface of the front windshield of the vehicle.

The air conditioner 1 for the vehicle of this embodiment includes an electric defogger (not shown). The electric defogger is a heating wire disposed inside or on the surface of the windshield in the vehicle compartment, and serves as a windshield heating means for heating the windshield so as to prevent fogging or to defog. Also, the electric defogger can have its operation controlled by a control signal output from the air conditioning controller 50.

Further, the air conditioner 1 for the vehicle of this embodiment includes a seat air conditioner 90 serving as an auxiliary heating means for increasing the temperature of the surface of a seat on which a passenger sits. Specifically, the seat air conditioner 90 is formed of a heating wire embedded in the surface of the seat, and serves as a seat heating means for generating heat by being supplied with power.

When the conditioned air blown from the air outlets 24 to 26 of the indoor air conditioning unit 10 cannot sufficiently heat the vehicle interior, the seat air conditioning unit 10 is operated to compensate for the insufficient warming to the passenger. The seat air conditioner 90 has its operation controlled by a control signal output from the air conditioning controller 50. In operation, the seat air conditioner 90 is controlled to increase the temperature of the surface of the seat up to about 40° C.

Next, the electric controller of this embodiment will be described with reference to FIG. 2. The air conditioning controller 50 and the driving force controller 70 are comprised of the well-known microcomputers, including CPU, ROM, and RAM, and peripheral circuits thereof. The controllers 50 and 70 performs various kinds of computations and processing based on air conditioning control programs stored in the ROM to control the operation of each device connected to the output side.

A driving force controller 70 has its output side connected to various kinds of components of engine forming the internal combustion engine EG, and an inverter for traveling that supplies an AC current to the electric motor for traveling. Specifically, various components of the engine connected include a starter for activating the engine EG, and a driving circuit (both not shown) for a fuel injection valve (injector) for supplying fuel to the engine EG.

The input side of the driving force controller 70A is connected to a group of various sensors for control of the engine. The sensors include a voltmeter for detecting a voltage VB between terminals of the battery 81; an ammeter for detecting a current ABin flowing into the battery 81 or a current About flowing from the battery 81; an accelerator position sensor for detecting an accelerator position (i.e. a degree of opening of an accelerator of the vehicle) Acc; an engine speed sensor for detecting the number of revolutions of the engine Ne; and a vehicle speed sensor for detecting a vehicle speed Vv (any of the sensors not shown).

The output side of the air conditioning controller 50 is connected to the blower 32, the inverter 61 for the electric motor 11b of the compressor 11, the blower fan 12a, various electric actuators 62, 63, and 64, the first to third PTC heaters 37a, 37b, and 37c, a coolant pump 40a, the sheet air conditioner 90, and the like.

The input side of the air conditioning controller 50 is connected to another group of various sensors for control of air conditioning. The sensors include an inside air sensor 51 (an interior temperature detection means) for detecting a temperature Tr of the vehicle interior; an outside air temperature sensor 52 (an outside air temperature detection means) for detecting a temperature Tam of the outside air; and a solar radiation sensor 53 (a solar radiation detection means) for detecting an amount Ts of solar radiation in the vehicle interior. The sensors also include a discharge temperature sensor 54 (a discharge temperature detection means) for detecting a temperature Td of the refrigerant discharged from the compressor 11; a discharge pressure sensor 55 (a discharge pressure detection means) for detecting a pressure Pd of the refrigerant discharged from the compressor 11; and an evaporator temperature sensor 56 (en evaporator temperature detection means) for detecting a temperature TE (evaporator temperature) of air blown from the evaporator 15. The sensors further include a coolant temperature sensor 58 (a coolant temperature detection means) for detecting a temperature Tw of coolant flowing from the internal combustion engine EG; a humidity sensor serving as a humidity detection means for detecting a relative humidity of air near the windshield in the vehicle interior; a near-windshield temperature sensor for detecting a temperature of air near the windshield in the vehicle interior; and a windshield surface temperature sensor for detecting a surface temperature of the windshield.

Specifically, the evaporator temperature sensor 56 of this embodiment detects the temperature of heat exchanging fins of the evaporator 15. Obviously, the evaporator temperature sensor 56 may employ a temperature detection means for detecting the temperature of another part of the evaporator 15. Alternatively, another temperature detection means may be used to directly detect the temperature of refrigerant itself flowing through the evaporator 15. Detected values obtained by the humidity sensor, the near-windshield temperature sensor, and the windshield surface temperature sensor are used to calculate the relative humidity RHW of the surface of the windshield.

Operation signals are input from various types of air conditioning operation switches provided on the operation panel 60 located near the instrument panel at the front of the vehicle compartment, to the input side of the air conditioning controller 50. Specifically, various air conditioning operation switches provided on the operation panel 60 include an operation switch for the air conditioner 1 for the vehicle, an automatic switch, a selector switch for switching among operation modes, and another selector switch for switching among air outlet modes. The air conditioning operation switches also include an air volume setting switch for the blower 32, a vehicle-interior temperature setting switch, an economy switch, and a display unit for displaying the present operation state of the air conditioner 1 for the vehicle.

The automatic switch serves as an automatic control setting means for setting or releasing automatic control of the air conditioner 1 for the vehicle by a passenger's operation. The vehicle-interior temperature setting switch serves as a target temperature setting means for setting a target vehicle interior temperature Tset by another passenger's operation. The economy switch serves as a power saving request means for outputting a power saving request signal for requesting the power saving which would be required for the air conditioning of the vehicle interior, by being turned on by the passenger.

Further, by turning on the economy switch, another signal for decreasing the frequency of the operation of the internal combustion engine EG for assisting the electric motor for traveling is output to the driving force controller 70 in the EV operation mode. The state of the economy switch turned on is hereinafter referred to as an “eco mode”.

The air conditioning controller 50 is electrically connected to and communicable with the driving force controller 70. With this arrangement, based on a detection signal or operation signal input to one of the controllers, the operation of various devices connected to the output side of the other controller can be controlled. For example, when the air conditioning controller 50 outputs a request signal of the internal combustion engine EG to the driving force controller 70, the internal combustion engine EG can be operated, or the number of revolutions of the internal combustion engine EG can be changed.

The air conditioning controller 50 and the driving force controller are integrally formed with a control means for controlling various devices of interest for control which are connected to the outputs of the controllers. The control means for controlling the operations of the devices of interest for control include the structures (hardware and software) for controlling the operations of various devices of interest for control.

For example, a compressor control means is comprised of the structure of the air conditioning controller 50 that controls a refrigerant discharge capacity of the compressor 11 by controlling the frequency of AC voltage output from the inverter 61 connected to the electric motor 11b of the compressor 11. Further, a blower control means is comprised of the structure of the air conditioning controller that controls a blowing capacity of the blower 32 by controlling the operation of the blower 32 serving as a blowing means. The structure that transmits and receives a control signal to and from the driving force controller 70 forms a request signal output means 50a.

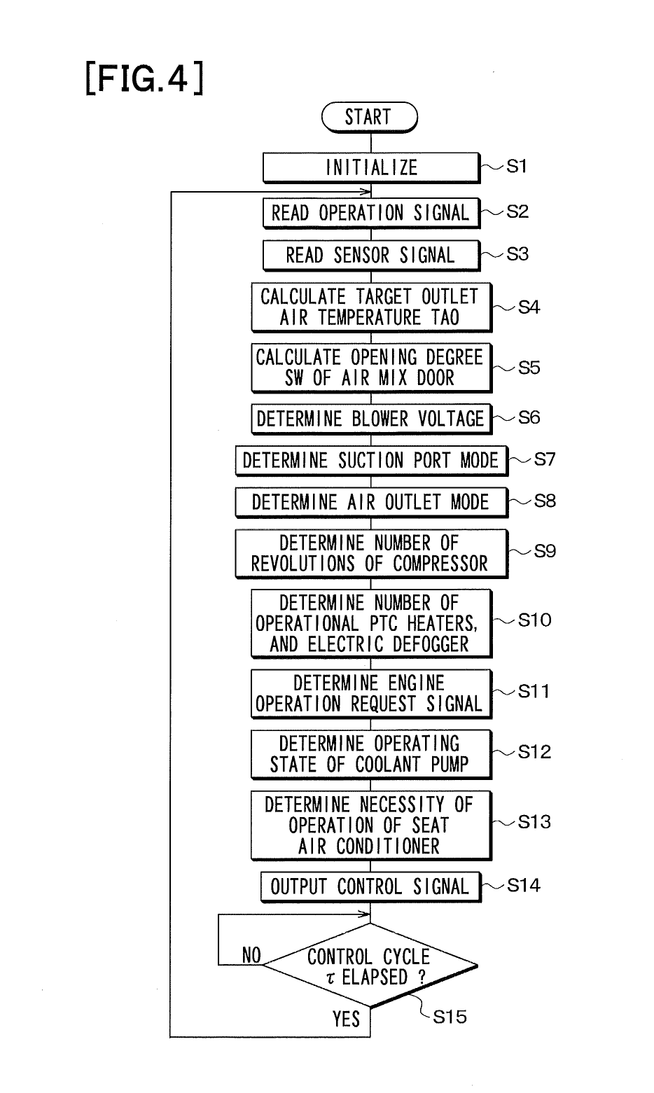

Now, the operation of the air conditioner 1 for the vehicle of this embodiment with the above arrangement will be described with reference to FIGS. 4 to 10. FIG. 4 shows a flowchart of a control process of the air conditioner 1 for the vehicle as a main routine in this embodiment. The control process is started by turning on the automatic switch while the operation switch of the air conditioner 1 for the vehicle is being turned on. The respective control steps shown in FIGS. 4 to 8 serve as various function achieving means included in the air conditioning controller 50.

In step S1, first, a flag, a timer, and the like are initialized. And, initial alignment of a stepping motor included in the above electric actuator is performed. The initialization includes maintaining the flag or calculated value stored after the last operation of the air conditioner 1 for the vehicle.

In next step S2, an operation signal is read from the operation panel 60, and then the operation proceeds to step S3. Specifically, the operation signals include a target vehicle interior temperature Tset set by the vehicle-interior temperature setting switch, a setting signal of the air outlet mode switch, a power saving request signal output according to the operation of the economy switch, and the like.

Then, in step S3, signals indicative of the environmental state of the vehicle to be used for control of air conditioning, that is, detection signals from the above sensor groups 51 to 58 are read. In step S3, the detection signal from a group of sensors connected to the input side of the driving force controller 70, as well as parts of the control signals output from the driving force controller 70 are also read from the driving force controller 70.

Then, in step S4, a target outlet air temperature TAO of blown air into the vehicle interior is calculated. The target outlet air temperature TAO is calculated by the following mathematical formula F1:

TAO=Kset×Tset−Kr×Tr−Kam×Tam−Ks×Ts+C (F1)
where Tset is a vehicle interior preset temperature set by the vehicle-interior temperature setting switch, Tr is a vehicle interior temperature (inside air temperature) detected by the inside air sensor 51, Tam is an outside air temperature detected by the outside air temperature sensor 52, and Ts is an amount of solar radiation detected by the solar radiation sensor 53. Furthermore, Kset, Kr, Kam, and Ks are control gains, and C is a constant for correction.

In subsequent steps S5 to S13, the control conditions of the respective components connected to the air conditioning controller 50 are determined. In step S5, first, a target opening degree SW of the air mix door 39 is calculated based on the above target outlet air temperature TAO, the blown air temperature TE detected by the evaporator temperature sensor 56, and the coolant temperature Tw.

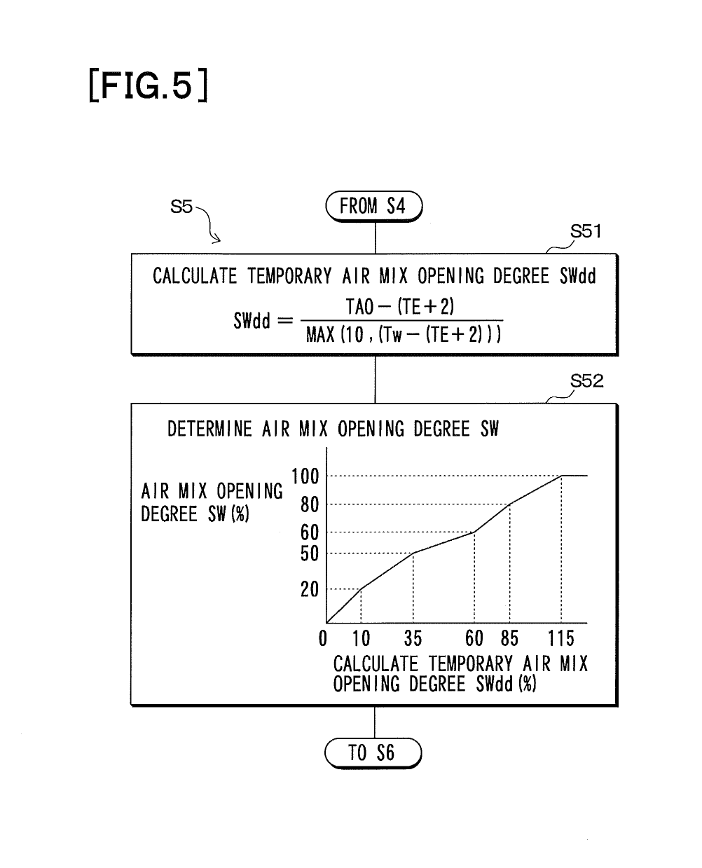

The details of the process in step S5 will be described below using the flowchart of FIG. 5. In step S51, first, a temporary air mix opening degree SW is calculated by the following formula F2, and then the operation proceeds to step S52.

SWdd=[{TAO−(TE+2)}/{MAX(10,Tw−(TE+2))}]×100(%) (F2).

Note that the term {MAX (10,Tw−(TE+2))} of the formula F2 means a larger one of the 10 and the “Tw−(TE+2)”.

Subsequently, in step S52, an air mix opening degree SW is determined with reference to the control map previously stored in the air conditioning controller 50 based on the temporary air mix opening degree SWdd calculated in step S51, and then the operation proceeds to step S6. The control map non-linearly determines the air mix opening degree SW with respect to the temporary air mix opening degree SWdd as shown in step S52 of FIG. 5.

This is based on the following reason. As mentioned above, this embodiment employs the cantilever door as the air mix door 39, which shows the non-linear relationship between changes in opening area of the cool air bypass passage 34 and in opening area of the cool air passage 33 for heating as viewed in the flow direction of the actual blown air with respect to a change in air mix opening degree SW.

The case of SW=0(%) indicates the maximum cooling position of the air mix door 39 in which the cool air bypass passage 34 is fully opened, and the cool air passage 33 for heating is completely closed. In contrast, the case of SW=100% indicates the maximum heating position of the air mix door 39 in which the cool air bypass passage 34 is completely closed, and the cool air passage 33 for heating is fully opened.

In next step S6, a blowing capacity (amount of blown air) of the blower 32 is determined. Specifically, the blowing capacity of the blower 32 (specifically, a blower motor voltage applied to the electric motor) is determined with reference to the control map previously stored in the air conditioning controller 50 based on the target outlet air temperature TAO determined in step S4.

More specifically, in this embodiment, the volume of air from the blower 32 is controlled to about the maximum by setting the blower motor voltage to a high voltage near the maximum voltage in a supercold temperature range (maximum cooling range) of the TAO and in a superhot temperature range (maximum heating range) thereof. As the TAO is increased from the supercold temperature range to an intermediate temperature range, the blower motor voltage is decreased with increasing TAO, thereby decreasing the volume of air from the blower 32.

As the TAO is decreased from the superhot temperature range to the intermediate temperature range, the blower motor voltage is decreased with decreasing TAO, thereby decreasing the volume of air from the blower 32. When the TAO enters the predetermined intermediate temperature range, the blower motor voltage is minimized to thereby minimize the volume of air from the blower 32.

In next step S7, a suction port mode, that is, the state of switching of the inside/outside air switching box is determined. The suction port mode is also determined based on the TAO with reference to the control map previously stored in the air conditioning controller 50. In this embodiment, basically, an outside air mode for introducing an outside air has higher priority over other modes. However, when the TAO is in the supercold region and the high cooling performance is desired, an inside air mode for introducing an inside air is selected. Further, an exhaust gas concentration detecting means is provided for detecting the concentration of exhaust gas of the outside air. When the concentration of exhaust gas is equal to or higher than a predetermined reference concentration, the inside air mode may be selected.

In next step S8, the air outlet mode is determined. The air outlet mode is also determined based on the TAO with reference to the control map previously stored in the air conditioning controller 50. In this embodiment, as the TAO is increased from the low temperature range to the high temperature range, the air outlet mode is switched from the foot mode to the bi-level mode and the face mode in that order.

Thus, in summer the face mode is mainly selected, in spring and autumn the bi-level mode is mainly selected, and in winter the foot mode is mainly selected. When the fogging of the windshield is supposed to be most likely to be caused based on the detected value of the humidity sensor, the foot/defroster mode or defroster mode may be selected.

In next step S9, a refrigerant discharge capacity of the compressor 11 (specifically, the number of revolutions (rpm)) is determined. In step S9, a target blown air temperature TEO of the blown air temperature Te of the air from the indoor evaporator 15 is determined based on the TAO or the like determined in step S4 with reference to the control map previously stored in the air conditioning controller 50.

A deviation En (TEO−Te) between the target blown air temperature TEO and the blown air temperature Te is calculated. A rate of change in deviation Edot (En−(En−1)) is obtained by subtracting the deviation En−1 previously calculated from the deviation En currently calculated. The deviation En and the rate of change in deviation Edot(En−(En−1)) are used to determine an amount of change in number of revolutions Δf_C of the compressor with respect to the previous number of revolutions fCn−1 of the compressor according to fuzzy inference based on a membership function and rule previously stored in the air conditioning controller 50.

In the membership function and rule previously stored in the air conditioning controller 50 of this embodiment, the amount of change in number of revolutionsΔf_C is determined based on the above deviation En and the change in deviation Edot so as to prevent the frost formation of the indoor evaporator 15. The present number of revolutions fn of the compressor is updated by adding the change in number of revolutions Δf_C to the previous number of revolutions fn−1 of the compressor. The number of revolutions fn of the compressor is updated in a control cycle of one second.

In next step S10, the number of PTC heaters 37 to be operated and the operating state of an electric defogger are determined. First, the determination of the number of the operational PTC heaters 37 will be described below. In step S10, the number of the operational PTC heaters 37 is determined according to the outside air temperature Tam, the coolant temperature Tw, and the temporary air mix opening degree SWdd determined in step S51.

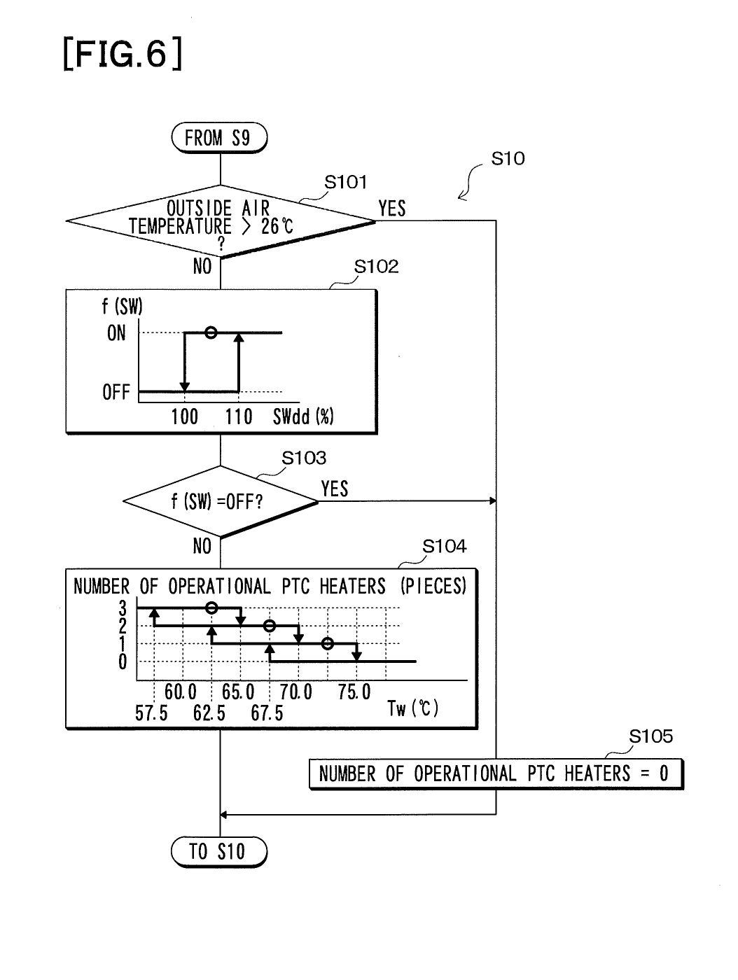

The details of the process in step S10 will be described below using the flowchart of FIG. 6. First, in step S101, it is determined whether the operation of the PTC heaters 37 is necessary or not based on the temperature of outside air. Specifically, it is determined whether or not the outside air temperature detected by the outside air temperature sensor 52 is higher than a predetermined temperature (26° C. in this embodiment).

When the outside air temperature is determined to be higher than 26° C. in step S101, the PTC heaters 37 are not required to assist in increasing the temperature of blown air, and then the operation proceeds to step S105, in which the number of the PTC heaters 37 to be operated is determined to be zero (0). When the outside air temperature is determined to be lower than 26° C. in step S101, the operation proceeds to step S102.

In steps S102 and S103, it is determined whether the operation of the PTC heater 37 is necessary or not based on the temporary air mix opening degree SWdd. The small temporary air mix opening degree SWdd means that the blown air does not need to be heated in the cool air passage 33 for heating. As the air mix opening degree SW is decreased, the necessity of the operation of the PTC heater 37 is reduced.

When the air mix opening degree SW determined in step S5 is compared with the predetermined reference opening degree, and is determined to be equal to or less than a first reference opening degree (100% in this embodiment) in step S102, the PTC heater 37 does not need to be operated, whereby a PTC heater operation flag f(SW) is set OFF (that is, f(SW)=OFF).

In contrast, when the air mix opening degree is equal to or more than a second reference opening degree (110% in this embodiment), the PTC heater 37 needs to be operated, whereby a PTC heater operation flag f(SW) is set ON (that is, f(SW)=ON). A difference between the first reference opening degree and the second reference opening degree is set as a hysteresis width to prevent the control hunting.

When the PTC heater operation flag f(SW) determined in step S102 is OFF in step S103, the operation proceeds to step S105, in which the number of operational PTC heaters 37 is determined to be zero (0). When the PTC heater operation flag f(SW) is ON, the operation proceeds to step S104, in which the number of operational PTC heaters 37 is determined. Then, the operation proceeds to step S11.

In step S104, the number of the PTC heaters 37 to be operated is determined according to the coolant temperature Tw. Specifically, while the coolant temperature Tw is increasing, the number of the operational PTC heaters 37 is determined to be three in the case of coolant temperature Tw<first predetermined temperature T1, two in the case of first predetermined temperature T1≦coolant temperature Tw<second predetermined temperature T2, one in the case of second predetermined temperature T2≦coolant temperature Tw<third predetermined temperature T3, and zero (0) in the case of third predetermined temperature T3≦coolant temperature Tw.

In contrast, while the coolant temperature Tw is decreasing, the number of the operational PTC heaters 37 is determined to be zero (0) in the case of fourth temperature T4<coolant temperature Tw, one in the case of fifth predetermined temperature T5<coolant temperature Tw≦ fourth predetermined temperature T4, two in the case of sixth predetermined temperature T6<coolant temperature Tw≦fifth predetermined temperature T5, and three in the case of coolant temperature Tw≦sixth predetermined temperature T6. Then, the operation proceeds to step S11.

The respective predetermined temperatures T1 to T6 have the relationship of T3>T2>T4>T1>T5>T6. In this embodiment, specifically, T3=75° C., T2=70° C., and T4=67.5° C., T1=65° C., T5=62.5° C., and T6=57.5° C. While the coolant temperature is increasing, and decreasing, a difference between the respective predetermined temperatures is set as a hysteresis width to prevent the control hunting.

When fogging is more likely to be caused on the windshield due to the humidity and temperature of the vehicle interior, or when fogging occurs on the windshield, the electric defogger is actuated.

In next step S11, a request signal output from the air conditioning controller 50 to the driving force controller 70 is determined. The request signals include an operation request signal of the internal combustion engine EG (engine ON request signal), and a stopping request signal of the internal combustion engine EG (engine OFF request signal).

In normal vehicles that obtain the driving force for traveling only from the internal combustion engine EG, the engine is normally being operated during traveling, which constantly keeps the coolant at high temperature. Thus, the normal vehicles can exhibit the sufficient heating capacity only by allowing the coolant to flow through the heater core 14.

On the other hand, the plug-in hybrid car of this embodiment sometimes obtains the driving force for traveling only from the electric motor during traveling in the EV operation mode. Even in the HV operation mode, the hybrid car can often travel with the reduced output from the internal combustion engine EG due to an increase in power assisted by the electric motor for traveling. In some cases, even when the high heating capacity is needed, the coolant temperature Tw is not increased up to the sufficient temperature as the heat source for heating.

For this reason, when the coolant temperature Tw does not rise to the sufficient temperature as the heat source for heating regardless of the necessity of the high heating capacity, the air conditioner 1 for the vehicle of this embodiment is adapted to output the request signal for operating the internal combustion engine EG at the predetermined number of revolutions from the air conditioning controller 50 to the driving force controller 70 in order to increase the coolant temperature Tw. Thus, the air conditioner 1 can obtain the high heating capacity by increasing the coolant temperature Tw.

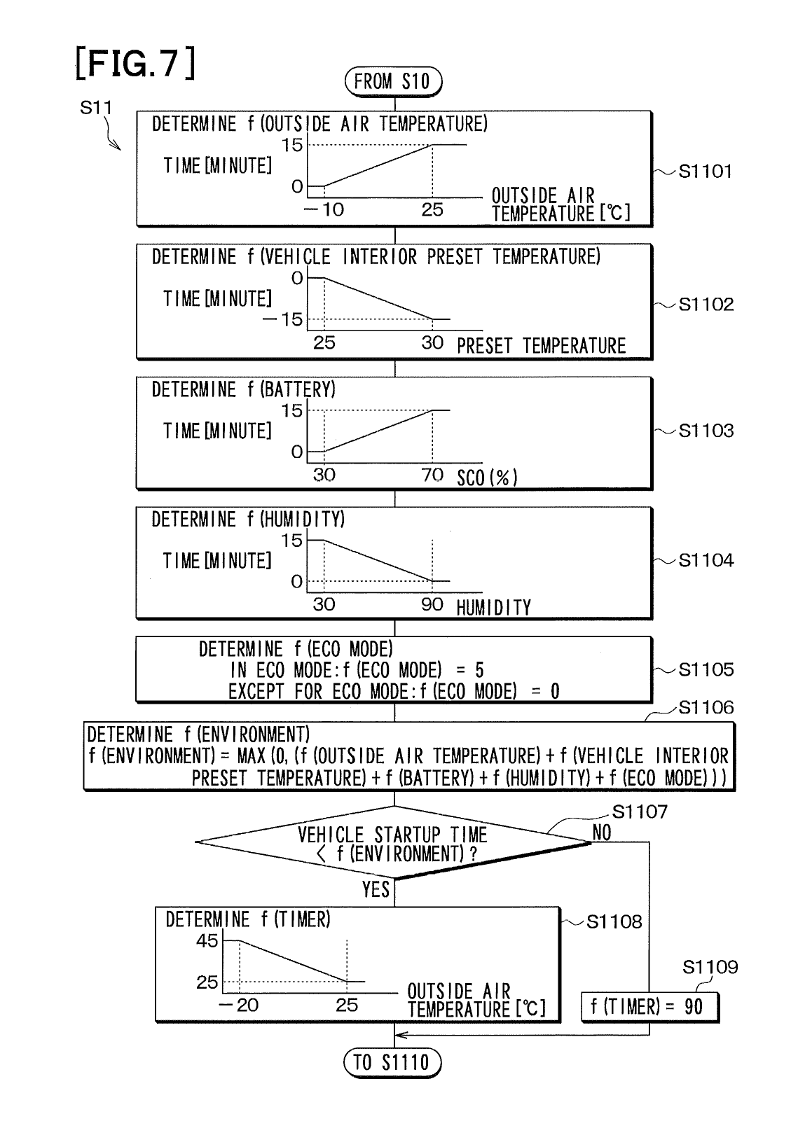

The details of the process in step S11 will be described below with reference to the flowcharts of FIGS. 7 to 9. In step S1101, first, a value f (outside air temperature) is determined based on the outside air temperature Tam detected by the outside air temperature sensor 52 with reference to the control map previously stored in the air conditioning controller 50. The value f (outside air temperature) is a value used for determination of an engine ON request suppression time f (environment) to be described later.

In this embodiment, specifically, in step S1101 shown in FIG. 7, as the outside air temperature Tam becomes lower, the value f (outside air temperature) is determined to be smaller.

In subsequent step S1102, another value f (vehicle interior preset temperature) is determined based on the vehicle interior preset temperature Tset set by the vehicle-interior temperature setting switch of the operation panel 60 with reference to the control map previously stored in the air conditioning controller 50. The value f (vehicle interior preset temperature) is a value used for determination of an engine ON request suppression time f (environment) to be described later.

In this embodiment, specifically, in step S1102 shown in FIG. 7, as the vehicle interior preset temperature Tset becomes higher, the value f (vehicle interior preset temperature) is determined to be smaller.

In subsequent step S1103, another value f (battery) is determined based on the remaining storage level SOC of the battery 81 with reference to the control map previously stored in the air conditioning controller 50. The value f (battery) is a value used for determination of an engine ON request suppression time f (environment).

In this embodiment, specifically, in step S1103 shown in FIG. 7, as the remaining storage level SOC becomes higher, the value f (battery) is determined to be larger.

In subsequent step S1104, another value f (humidity) is determined based on the relative humidity of the air in the vehicle interior detected by the humidity sensor with reference to the control map previously stored in the air conditioning controller 50. The value f (humidity) is a value used for determination of the engine ON request suppression time f (environment).

In this embodiment, specifically, in step S1104 shown in FIG. 7, as the relative humidity of the indoor air becomes lower, the value f (humidity) is determined to be larger.

In subsequent step S1105, another value f (eco mode) is determined based on whether the economy switch is turned on (ON) or not. The value f (eco mode) is a value used for determination of an engine ON request suppression time f (environment).

In this embodiment, specifically, in step S1105 shown in FIG. 7, when the economy switch is turned on (ON) (in the eco mode), the value f (eco mode) is determined to be large, whereas when the economy switch is not turned on (ON) (not in the eco mode), the value f (eco mode) is determined to be small.

In subsequent step S1106, the engine ON request suppression time f (environment) is determined based on the value f (outside air temperature), the value f (vehicle interior preset temperature), the value f (battery), the value f(humidity), and the value f(cco mode) which are determined in steps S1101 to S1105. Then, the operation proceeds to step S1107.

The engine ON request suppression time f (environment) is a value determined as a period of time (predetermined time) for suppressing output of the engine ON request signal from the air conditioning controller 50 to the driving force controller 70 at the startup of the vehicle (directly after the startup of the vehicle). Thus, the process in step S1106 provides a time determination means for determining the predetermined time. Specifically, the engine ON request suppression time f (environment) is determined by the following mathematical formula F3.

F(environment)=MAX[0,{f(outside air temperature)+f(vehicle interior preset temperature)+f(battery)+f(humidity)+f(eco mode)}] (F3)

In the formula (F3), the MAX[0, {f(outside air temperature)+f (vehicle interior preset temperature)+f(battery)+f(humidity)+f(eco mode)} means a larger one of 0 and {f(outside air temperature)+f (vehicle interior preset temperature)+f (battery)+f(humidity)+f(eco mode)}.

As mentioned in the description of the control step S1101, as the outside air temperature Tam becomes lower, the value f (outside air temperature) is determined to be smaller. As the outside air temperature Tam becomes higher, the engine ON request suppression time f (environment) becomes longer.

As mentioned in the description of the control step S1102, as the vehicle interior preset temperature Tset becomes higher, the value f (vehicle interior preset temperature) is determined to be smaller. As the vehicle interior preset temperature Tset becomes higher, the engine ON request suppression time f (environment) becomes shorter.

As mentioned in the description of the control step S1103, as the remaining storage level SOC of the battery 81 becomes larger, the value f (battery) is determined to be larger. As the remaining storage level SOC becomes higher, the engine ON request suppression time f (environment) becomes longer.

As mentioned in the description of the control step S1104, as the relative humidity of the air in the vehicle interior becomes lower, the value f(humidity) is determined to be larger. As the relative humidity of the air in the vehicle interior becomes lower, the engine ON request suppression time f (environment) becomes longer.

As mentioned in the description of the control step S1105, when the economy switch is turned on (ON) (in the eco mode), the value f (eco mode) is determined to be large as compared to when the economy switch is not turned on (ON) (except for the eco mode). Thus, when the economy switch is turned on (ON) (in the eco mode), the engine ON request suppression time f (environment) is determined to be longer as compared to when the economy switch is not turned on (ON) (except for the eco mode).

In subsequent steps S1107 to S1109, a temporary upper limit temperature f (TIMER) of the coolant is determined based on an elapse time after startup of the vehicle (hereinafter referred to as a “vehicle startup time”). The temporary upper limit temperature f (TIMER) of the coolant is a value determined to suppress the operation of the internal combustion engine EG at the startup of the vehicle.

More specifically, in steps S1107 to S1109, as described in the step S1116 to be described later, when the vehicle startup time does not reach the engine ON request suppression time f (environment), the temporary upper limit temperature f (TIMER) is determined such that the engine OFF water temperature Twoff is set low.

Specifically, in step S1107, it is determined whether or not the vehicle startup time reaches the engine ON request suppression time f(environment). When the vehicle startup time does not reach the value f(environment) (If YES), the operation proceeds to step S1108, in which the temporary upper limit temperature f(TIMER) of the coolant is set lower, and then the operation proceeds to step S1110.

In this embodiment, in step S1108 shown in FIG. 7, as the outside air temperature Tam increases, the temporary upper limit temperature f(TIMER) is determined to be gradually decreased. Further, the temporary upper limit temperature f(TIMER) is determined to be in a range of 25 to 45° C.

When the vehicle startup time reaches the engine ON request suppression time f (environment) (If No) in step S1107, the operation proceeds to step S1109, in which the temporary upper limit temperature f(TIMER) of the coolant is determined to be large, and then the operation proceeds to step S1110.

In this embodiment, in step S1109 shown in FIG. 7, the temporary upper limit temperature f(TIMER) is set to 90° C., which is higher than the temporary upper limit temperature f(TIMER)=25 to 45° C. determined in step S1108.

When the vehicle startup time does not reach the engine ON request suppression time f (environment), the temporary upper limit temperature f(TIMER) of the coolant is determined to be small as compared to when the vehicle startup time does not reach the engine ON request suppression time f (environment).

In subsequent step S1110, the increase in temperature ΔTptc of blown air is determined based on the number of operated PTC heaters 37 determined in step S10. The value ΔTptc is an increase in temperature of blown air caused by the operation of the PTC heaters 37, that is, an increase in temperature contributed by heat generation of the PTC heaters 37, among the respective temperatures of conditioned areas (blown air temperatures) blown from the air outlets 24 to 26 into the vehicle interior.

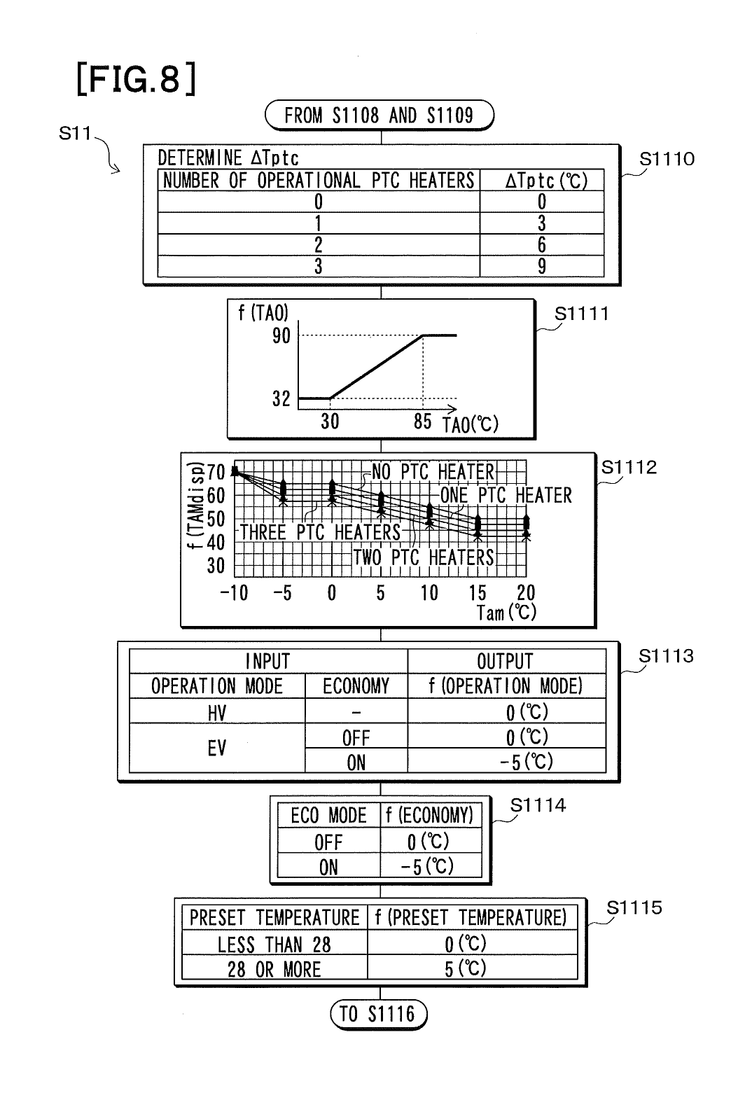

Thus, an increase in blown air temperature ΔTptc becomes larger with increasing number of the operated PTC heaters 37. In this embodiment, specifically, in step S1110 shown in FIG. 8, when the number of operated PTC heaters 37 is zero (0), the ΔTptc is 0° C. (ΔTptc=0° C.). Further, when the number of operated PTC heaters 37 is one, the ΔTptc is 3° C. (ΔTptc=3° C.). Further, when the number of operated PTC heaters 37 is two, the ΔTptc is 6° C. (ΔTptc=6° C.). Moreover, when the number of operated PTC heaters 37 is three, the ΔTptc is 9° C. (ΔTptc=9° C.).

In subsequent step S1111, a target coolant temperature f(TAO) is determined based on the TAO determined in step S4 with reference to the control map previously stored in the air conditioning controller 50. The target coolant temperature f(TAO) is a value determined as the desirable coolant temperature Tw for the air conditioner to exhibit the sufficient heating capacity.

Thus, the control step S1111 of this embodiment serves as a target temperature determination means for determining the target coolant temperature (f(TAO)). In this embodiment, specifically, in step S1111 shown in FIG. 8, the f(TAO) is determined to increase with increasing TAO.

In subsequent step S1112, a temporary upper limit of coolant temperature f(TAMdisp) is determined based on the outside air temperature Tam and the number of the PTC heaters 37 determined in step S10 with reference to the control map previously stored in the air conditioning controller 50. The temporary upper limit temperature f(TAMdisp) is a value determined that allows the vehicle air conditioner to exhibit the sufficient heating capacity not to increase the frequency of the unnecessary operation of the internal combustion engine EG.

In this embodiment, specifically, in step S1112 shown in FIG. 8, the temporary upper limit temperature f(TIMdisp) is determined to gradually decrease with increasing outside air temperature Tam. As the number of the PTC heaters 37 is decreased, the temporary upper limit temperature f(TAMdisp) is determined to be decreased.

In subsequent step S1113, an operation mode correction term f (operation mode) to be added to the temporary upper limit temperature f(TAMdisp) is determined based on the operation mode of the vehicle. Specifically, in step S1113, when the operation mode of the vehicle is the HV operation mode, the operation mode correction term f(operation mode) is determined to be 0° C., regardless of turning on the economy switch.

When the operation mode is the EV operation mode and the economy switch is turned on, the operation mode correction term f (operation mode) is determined to −5° C. When the operation mode is the EV operation mode and the economy switch is not turned on, the operation mode correction term f (operation mode) is determined to 0° C.

More specifically, in step S1113, when the economy switch is turned on (ON) under the EV operation mode, the operation mode correction term f(operation mode) is determined such that an engine OFF water temperature Twoff to be described later is set low as compared to that in the HV operation mode, as will be mentioned later in the description of step S1116.

In the hybrid car of this embodiment, as mentioned above, when the remaining storage level SOC of the battery 81 is equal to or more than the predetermined reference remaining level for traveling, the battery 81 is determined to have the sufficient remaining storage level SOC, which brings the hybrid car into the EV operation mode. In contrast, when the remaining storage level SOC of the battery is lower than the predetermined reference remaining level for traveling, the battery 81 is determined to have the insufficient remaining storage level SOC, which brings the hybrid car into the HV operation mode.

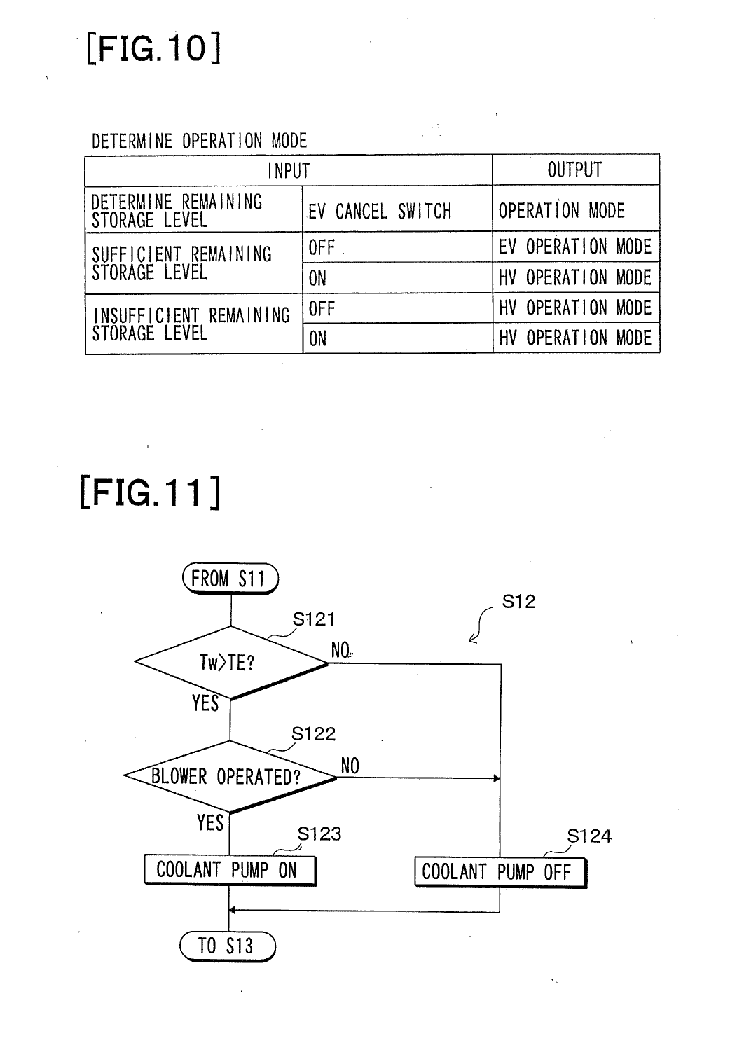

More specifically, the operation mode is determined according to Table of FIG. 10. When an EV cancellation switch is turned on (ON) by the passenger's operation to request the driving force controller 70 not to execute the EV operation mode, the HV operation mode is performed even if the remaining storage level SOC of the battery 81 is sufficient.

Next, in step S1114, an economy correction term f (economy), which is to be added to the temporary upper limit temperature f (TAMdisp), is determined based on whether the economy switch is turned on (ON) or not. Specifically, in step S110, when the economy switch is turned on, an economy correction term f (economy) is determined to be −5° C. When the economy switch is not turned on, an economy correction term f (economy) is determined to be zero (0)° C.

More specifically, in step S1114, when the economy switch serving as a power saving request means is turned on (ON), the economy correction term f(economy) is determined such that an engine OFF water temperature Twoff is set low as compared to when the economy switch is not turned on (OFF), as will be mentioned later in the description of step S1116.

In subsequent step S1115, a preset temperature correction term f (preset temperature), which is to be added to the temporary upper limit temperature f (TAMdisp), is determined based on the target vehicle interior temperature Tset set by the vehicle-interior temperature setting switch. Specifically, in step S1115, when the target vehicle interior temperature Tset is less than 28° C., the preset temperature correction term f (preset temperature) is determined to be zero (0)° C. When the temperature Tset is equal to or more than 28° C., the preset temperature correction term f (preset temperature) is determined to be 5° C.

More specifically, in step S1115, when the target vehicle interior temperature Tset set by the vehicle-interior temperature setting switch as the target temperature setting means is equal to or more than the predetermined target reference vehicle interior temperature (28° C. in this embodiment), the preset temperature correction term f (preset temperature) is determined such that the engine OFF water temperature Twoff becomes higher. In other words, the preset temperature correction term f (preset temperature) is determined such that as the target vehicle interior temperature Tset is decreased, the engine OFF water temperature Twoff is set lower.

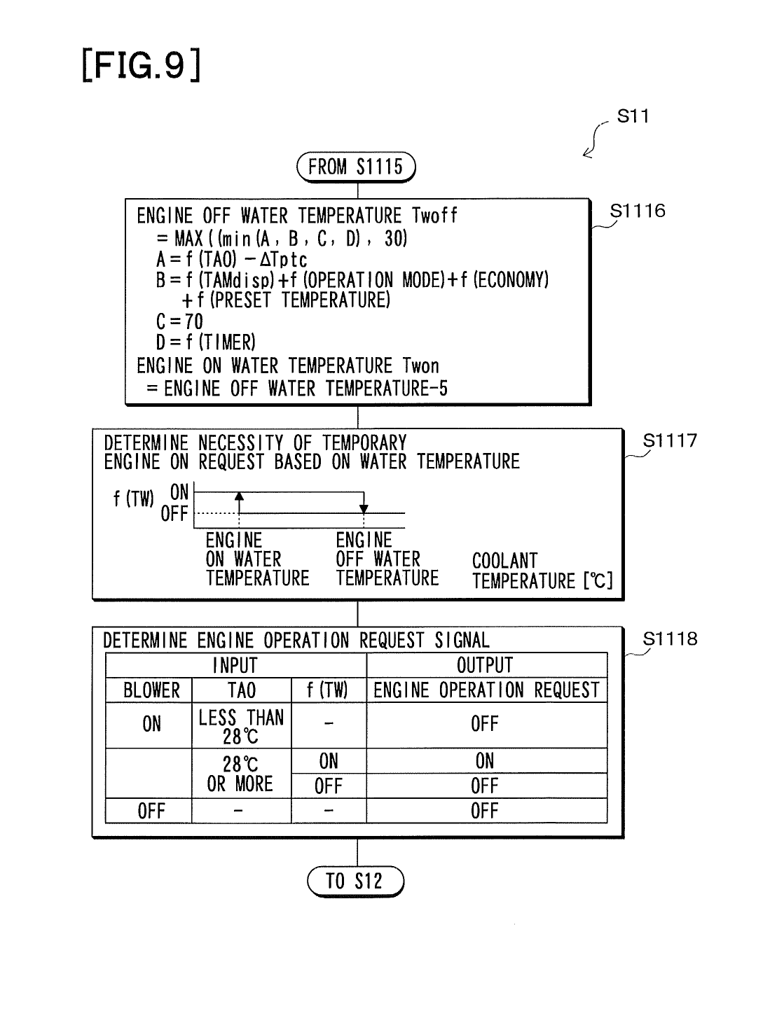

Then, in step S1116 shown in FIG. 9, the engine ON water temperature Twon and the engine OFF water temperature Twoff are determined as determination thresholds which are used to determine whether or not an operation request signal or operation stopping signal of the internal combustion engine EG is output based on the coolant temperature Tw. The engine ON water temperature Twon is a coolant temperature Tw serving as a criterion for judgment regarding whether the stopping request signal is output or not. The engine OFF water temperature Twoff is a coolant temperature Tw serving as a criterion for judgment regarding whether the operation stopping signal of the internal combustion engine EG is output or not.

That is, the engine OFF water temperature Twoff is the upper limit temperature at which the driving force controller 70 operates the internal combustion engine EG to increase the coolant temperature Tw. That is, the driving force controller 70 continues operating the internal combustion engine EG until the coolant temperature Tw reaches the engine OFF water temperature Twoff in increasing the coolant temperature Tw. Thus, the control step S1116 of this embodiment serves as an upper limit temperature determination means.

Specifically, the engine OFF water temperature Twoff is determined in the following method. As shown in step S1116 of FIG. 9, the method involves comparing a temperature of 30° C. with a smallest one of a temperature of 70° C., a value obtained by subtracting the increase in temperature ΔTptc of blown air from the target coolant temperature f(TAO), a value obtained by adding the operation mode correction term f(operation mode), the economy correction term f(economy), and the preset temperature correction term f(preset temperature) to the temporary upper limit temperature f(TAMdisp), and a value f(Timer); and then selecting a larger one of the above smallest value and the temperature of 30° C., as the engine OFF water temperature Twoff.

In step S1116, the value obtained by subtracting the blown air temperature increase ΔTptc from the target coolant temperature f(TAO) (indicated by reference numeral “A” of step S1116 shown in FIG. 9) is a value that is produced by subtracting the increase in temperature caused by operating the PTC heaters 37 from the desired coolant temperature Tw that allows the air conditioner 1 for the vehicle to exhibit the sufficient heating capacity. The setting of the above temperature as the engine OFF water temperature Twoff surely allows the air conditioner 1 for the vehicle to exhibit the sufficient heating capacity.

Next, the value (“B” of step S1116 of FIG. 9) obtained by adding the respective correction terms f (operation mode), f(economy), and f(present temperature) to the temporary upper limit temperature f(TAMdisp) is a value provided by correcting the coolant temperature Tw that does not increase the frequency of unnecessary operation of the internal combustion engine EG, based on the operation mode, the on/off state of the economy switch, and the target vehicle interior temperature Tset. The setting of the above temperature as the engine OFF water temperature Twoff can suppress the increase in frequency of the operation of the internal combustion engine EG.

Then, the temperature of 70° C. (“C” of step S1116 of FIG. 9) is the same as the maximum value of the temporary upper limit temperature f (TAMdisp) determined in step S1112. The temperature is a value determined as a protective value for surely outputting the operation stopping signal of the engine.

The temporary upper limit temperature f(TIMER) (indicated by reference numeral “D” in step S1116 shown in FIG. 9) is set to a small value in the vehicle startup time which does not achieve the engine ON request suppression time f (environment). The setting of the above temperature as the engine OFF water temperature Twoff can suppress the operation of the internal combustion engine EG during the startup of the vehicle.

Thus, by employing the lowest one among these temperatures, the engine OFF water temperature TWoff can be determined to be the desired coolant temperature Tw that allows the air conditioner for the vehicle to exhibit the high heating capacity, or the coolant temperature Tw that does not increase the frequency of operation of the internal combustion engine EG. In particular, during the startup of the vehicle, when the temporary upper limit temperature f (TIMER) becomes the smallest value, the engine OFF water temperature Twoff at the startup of the vehicle is determined to be small, which can suppress the operation of the internal combustion engine EG upon the startup of the vehicle.

The smallest value described above is compared with 30° C. determined as the lower limit of value which surely outputs the operation stopping signal of the engine, and then the bigger one of them is determined as the engine OFF water temperature Twoff, which can surely prevent the operation of the internal combustion engine EG from continuing due to the request from the air conditioner 1 for the vehicle.

In contrast, the engine ON water temperature Twon is set lower only by a predetermined value (in this embodiment, 5° C.) than the engine OFF water temperature Twoff so as to prevent the frequent ON/OFF of the engine. The predetermined value is set as a hysteresis width for preventing the control hunting.

In subsequent step S1117, a temporary request signal flag f(TW) indicative of whether or not the operation request signal or operation stopping signal of the internal combustion engine EG is output is determined according to the coolant temperature Tw. Specifically, when the coolant temperature Tw is lower than the engine ON water temperature Twon determined in step S1116, the temporary request signal flag f(Tw) is set to on (f(Tw)=ON), whereby the operation request signal of the internal combustion engine EG is temporarily determined to be output. When the coolant temperature Tw is higher than the engine OFF water temperature Twoff, the temporary request signal flag f(Tw) is set to off (f(Tw)=OFF), whereby the operation stopping request signal of the internal combustion engine EG is temporarily determined to be output.

In subsequent step S1118, a request signal to be output to the driving force controller 70 is determined based on the operating state of the blower 32, the target outlet air temperature TAO, and the temporary request signal flag f(Tw) with reference to the control map previously stored in the air conditioning controller 50. Then, the operation proceeds to step S12 shown in FIG. 4.

Specifically, in step S1118, when the blower 32 is operating and the target outlet air temperature TAO is less than 28° C., the request signal for stopping the internal combustion engine EG is determined regardless of the temporary request signal flag f(Tw).

While the blower 32 is operating and the target outlet air temperature TAO is equal to or more than 28° C., the request signal for operating the engine EG is determined when the temporary request signal flag f(Tw) is ON, or the request signal for stopping the engine EG is determined when the temporary request signal flag f(Tw) is OFF. When the blower 32 is not operating, the request signal for stopping the internal combustion engine EG is determined regardless of the target outlet air temperature TAO and the temporary request signal flag f(Tw).

As mentioned in the description of control step S1116, at startup of the vehicle, the engine OFF water temperature Twoff is often determined to be the temporary upper limit temperature f(TIMER), which is a small value. In this case, the temporary request signal flag f(Tw) is apt to be OFF, and the request signal for stopping the internal combustion engine EG tends to be determined, which prevents the request signal for operating the internal combustion engine EG from being output. Thus, the process in step S1118 serves as a suppression means for suppressing the output of the request signal from the request signal output means 50a to the driving force controller 70.

Then, in step S12 shown in FIG. 4, it is determined whether the coolant pump 40a for allowing the coolant to circulate between the heater core 36 and the internal combustion engine EG is operated or not in the coolant circuit 40.

The details of the process in step S12 will be described below using the flowchart of FIG. 11. In step S121, first, it is determined whether the coolant temperature Tw is higher than the blown air temperature TE.

When the coolant temperature Tw is determined to be equal to or less than the blown air temperature TE in step S121, the operation proceeds to step S124, in which the coolant pump 40a is determined to be stopped (turned OFF). The reason for this is that when the coolant temperature Tw is equal to or less than the blown air temperature TE and the coolant flows through the heater core 36, the coolant flowing through the heater core 36 happens to cool the air having passed through the evaporator 15, which leads to a decrease in temperature of the air blown from the air outlet.

When the coolant temperature Tw is determined to be higher than the blown air temperature TE in step S121, the operation proceeds to step S122. In step S122, it is determined whether the blower 32 is operating or not. When the blower 32 is determined not to be operating in step S122, the operation proceeds to step S124, in which the coolant pump 40a is determined to be turned off (OFF) for power saving.

When the blower 32 is determined to be operating in step S122, the operation proceeds to step S123, in which the coolant pump 40a is determined to be turned on (ON). Thus, the coolant pump 40a is operated to allow the coolant to circulate through the refrigerant circuit, so that the coolant flowing through the heater core 36 and the air passing through the heater core 36 can exchange heat therebetween to heat the blown air.

Then, in step S13, it is determined whether the operation of the seat air conditioner 90 is necessary or not. The operating state of the seat air conditioner 90 is determined based on the target outlet air temperature TAO determined in step S5, the operating state of the PTC heaters 37 determined in step S10, the target vehicle interior temperature Tset read in step S2, and the outside air temperature Tam with reference to the control map previously stored in the air conditioning controller 50.

Specifically, when the target outlet air temperature TAO is lower than 100° C. and the PTC heater 37 is operating, and when the outside air temperature Tam is equal to or less than the predetermined reference outside air temperature and the target vehicle interior temperature Tset is lower than the predetermined reference seat air conditioner operating temperature, the seat air conditioner 90 is determined to be operating (turned ON).

When the target outlet air temperature TAO is equal to or higher than 100° C., the seat air conditioner 90 is determined to be turned on (ON) regardless of the operating state of the PTC heater 37, the outside air temperature Tam, and the target vehicle interior temperature Tset. Even when the conditions for operating (turning on) the seat air conditioner 90 are satisfied and the economy switch of the operation panel 60 is turned on, the seat air conditioner 90 may be in a non-operating state (OFF).

In subsequent step S14, control signals and control voltages are output from the air conditioning controller 50 to various respective devices 32, 12a, 61, 62, 63, 64, 12a, 37, 40a, and 80 so as to obtain the control state determined in the above steps S5 to S13. The operation request signal of the internal combustion engine EG determined in step S11 is transmitted from the request signal output means 50c to the driving force controller 70.

Then, in step S15, when a control cycle τ is determined to have elapsed after standby for the control cycle τ, the operation returns to step S2. In this embodiment, the control cycle τ is set to 250 ms. This is because the delayed control cycle τ does not adversely affect the controllability of the air conditioning control of the vehicle interior as compared to the engine control or the like. For this reason, the communication volume for air conditioning control of the vehicle interior can be suppressed to sufficiently ensure communication volume of the control system requiring the high-speed control, such as the engine control.

The air conditioner 1 for the vehicle of this embodiment can be operated in the above way, whereby the air blown from the blower 32 is cooled by the evaporator 15. The cool air cooled by the evaporator 15 flows into the cool air passage 33 for heating and the cool air bypass passage 34 according to the opening degree of the air mix door 39.

The cool air flowing into the cool air passage 33 for heating is heated while passing through the heater core 36 and the PTC heater 37, and then mixed with another cool air passing through the cool air bypass passage 34 in the mixing space 35. The conditioned air whose temperature is adjusted in the mixing space 35 is blown from the mixing space 35 into the vehicle interior via the respective air outlets.

When the vehicle interior temperature Tr is cooled by the conditioned air blown into the vehicle interior to a lower temperature than the outside air temperature Tam, the cooling of the vehicle interior is achieved. In contrast, when the vehicle interior temperature Tr is heated to a higher temperature than the outside air temperature Tam, the heating of the vehicle interior is achieved.

In the air conditioner 1 for the vehicle of this embodiment, as mentioned in the description of control steps S1107, S1109, and S1116, the control step S1116 serving as the upper limit temperature determination means is adapted to determine the temporary upper limit temperature f(TIMER) of the coolant such that the engine OFF water temperature Twoff becomes small at the startup of the vehicle when the vehicle startup time does not reach the engine ON request suppression time f(environment).

Until a predetermined lime has elapsed since the startup of the vehicle (until a predetermined condition is satisfied), the coolant temperature Tw tends to reach the engine OFF water temperature Twoff, which suppress the output of the engine ON request signal from the request signal output means 50a to the driving force control member 70. That is, the air conditioner of this embodiment can suppress the operation of the internal combustion engine EG for increasing the coolant temperature at the startup of the vehicle.

Also, the air conditioner for the vehicle of this embodiment can suppress the passenger from feeling uncomfortable due to the operation of the engine while the battery is nearly fully charged. Further, the air conditioner for the vehicle can effectively use the charged power for traveling to thereby improve the fuel efficiency of the vehicle. The operation of the internal combustion engine EG can be suppressed to reduce vehicle exterior noise.

When the vehicle startup time reaches the engine ON request suppression time f(environment), the control step S1116 serving as the upper limit temperature determination means determines the temporary upper limit temperature f(TIMER) of the coolant such that the engine OFF water temperature Twoff is set to a high temperature as compared to the case in which the vehicle startup time does not reach the engine ON request suppression time f(environment).

The coolant temperature Tw is less likely to reach the engine OFF water temperature Twoff as the time has elapsed, which facilitates the operation of the internal combustion engine EG. Thus, this embodiment can improve the heating capacity to thereby make the passenger warmer as the time has elapsed.

In this embodiment, as mentioned in the description of control steps S1101 and S1106, the value f(outside air temperature) is determined such that as the outside air temperature Tam detected by the outside air temperature sensor 52 serving as the outside air temperature detection means become higher, the engine ON request suppression time f(environment) is made longer.

That is, as the outside air temperature Tam becomes higher, the air conditioner for the vehicle of this embodiment can suppress the operation of the internal combustion engine EG for increasing the coolant temperature at the startup of the vehicle. When the required heating capacity is small, the operation of the internal combustion engine EG that increases the coolant temperature at the startup of the vehicle can be suppressed more effectively.

In the description of control steps S1102 and S1106, this embodiment determines the value f(vehicle interior preset temperature) such that as the vehicle interior preset temperature Tset set by the vehicle-interior temperature setting switch serving as the target temperature setting means becomes higher, the engine ON request suppression time f(environment) is decreased.

That is, as the vehicle interior preset temperature Tset becomes higher, the air conditioner for the vehicle of this embodiment can more effectively suppress the operation of the internal combustion engine EG that might increase the coolant temperature at the startup of the vehicle. Thus, the air conditioner for the vehicle can exhibit its heating capacity according to the passenger's request at the startup, and thus can suppress the passenger from missing the warmth.

As mentioned in the description of control steps S1103 and S1106, this embodiment determines the value f(battery) such that as the remaining storage level SOC of the battery 81 becomes lower, the engine ON request suppression time f(environment) is decreased.

That is, as the remaining storage level SOC of the battery 81 becomes higher, the air conditioner of this embodiment can more effectively suppress the operation of the internal combustion engine EG for increasing the coolant temperature at the startup of the vehicle. Thus, the charged power can be more easily used for traveling at the startup, which can improve the fuel efficiency of the vehicle.

In this embodiment, as mentioned in the description of control steps S1104 and S1106, the value f(humidity) is determined such that as the relative humidity of the vehicle inside air detected by the humidity sensor serving as the humidity detection means becomes lower, the engine ON request suppression time f(environment) become longer.

That is, as the relative humidity of the air in the vehicle interior becomes lower, the operation of the internal combustion engine EG that might increase the coolant temperature can be more suppressed at the startup of the vehicle. When the fogging is less likely to be caused on the windshield and the necessity of blowing the warm air toward the windshield is eliminated, the operation of the internal combustion engine EG for increasing the coolant temperature can be effectively suppressed at the startup of the vehicle.

In this embodiment, as mentioned in the description of control steps S1105 and S1106, the value f(eco mode) is determined such that in turning on (ON) the economy switch as the power saving request means (in the eco mode), the engine ON request suppression time f(environment) is made long as compared to when the economy switch is not turned on (ON) (except for the eco mode).

In the eco mode requiring the power saving, the operation of the internal combustion engine EG that might increase the coolant temperature can be suppressed at the startup of the vehicle. Since the power saving is requested by the passenger, even though a heating capacity is slightly reduced by suppressing the operation of the internal combustion engine EG, the air conditioner cannot make the passenger uncomfortable at all.

### Second Embodiment

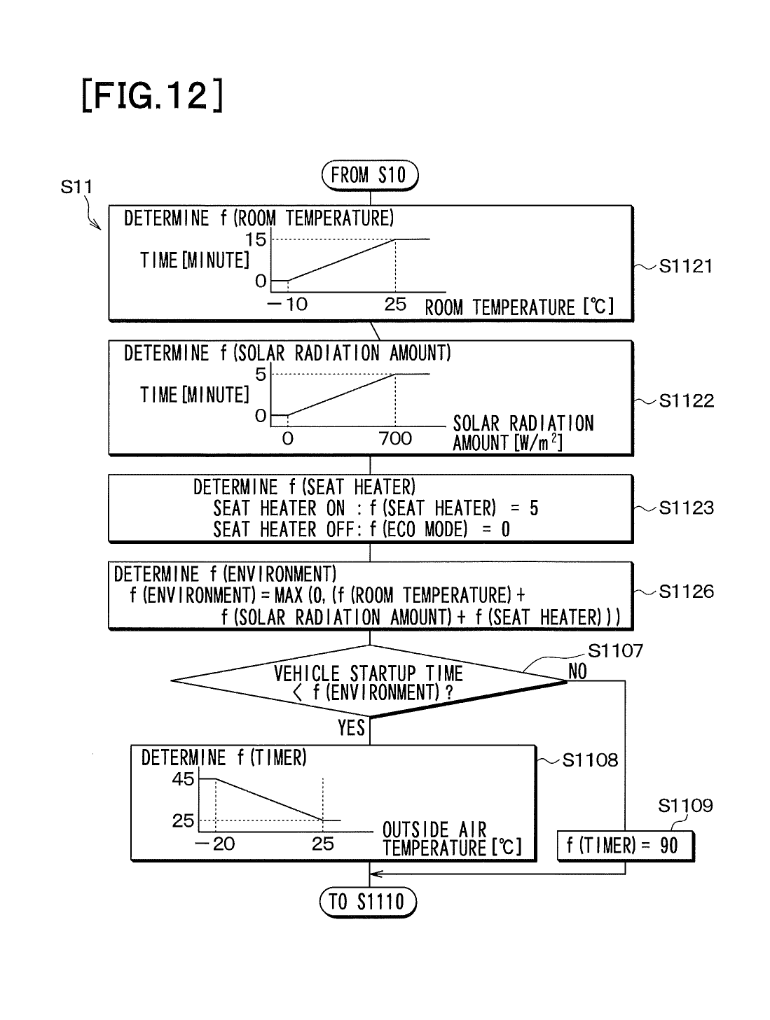

In the first embodiment, the engine ON request suppression time f(environment) is determined based on the outside air temperature, the vehicle interior preset temperature, the remaining storage level SOC of the battery 81, the relative humidity of the vehicle interior air, and the selected state of the eco mode. In contrast, in a second embodiment of the invention, as shown in FIG. 12, the engine ON request suppression time f(environment) is determined based on the room temperature, the solar radiation amount, and the operating state of the seat air conditioner 90.

In step S1121, first, the value f (room temperature) is determined based on the vehicle interior temperature Tr (inside air temperature) detected by the inside air sensor 51 with reference to the control map previously stored in the air conditioning controller 50. The value f (room temperature) is a value used for determination of an engine ON request suppression time f (environment).

In this embodiment, specifically, as mentioned in the description of step S1121 of FIG. 12, as the vehicle interior temperature Tr becomes higher, the value f(room temperature) is determined to be larger.

In subsequent step S1122, first, the value f (solar radiation amount) is determined based on the solar radiation amount Ts at the vehicle interior detected by the solar radiation sensor 53 with reference to the control map previously stored in the air conditioning controller 50. The value f (solar radiation) is a value used for determination of the engine ON request suppression time f (environment).

In this embodiment, specifically, in step S1122 shown in FIG. 12, as the solar radiation amount Ts becomes more, the value f (solar radiation amount) is determined to be larger.

In subsequent step S1123, the value f(seat heater) is determined based on the operating state of the seat air conditioner 90. The value f (seat heater) is a value used for determination of the engine ON request suppression time f (environment).

In this embodiment, specifically, in step S1123 shown in FIG. 12, when the seat air conditioner 90 is operating (when the scat heater is turned ON), the value f(seat heater) is determined to be large as compared to when the seat air conditioner 90 is not operating (when the seat heater is turned OFF).

In subsequent step S1126, the engine ON request suppression time f (environment) is determined based on the value f(room temperature), the value f (solar radiation amount), and the value f(seat heater) determined in steps S1121 to S1123, and then the operation proceeds to step S1107. Specifically, the engine ON request suppression time f(environment) is determined by the following mathematical formula F4:

f(environment)=MAX[0,{f(room temperature)+f(solar radiation amount)+f(seat heater)}] (F4)

The term “MAX [0, {f(room temperature)+f(solar radiation amount)+f(seat heater)}]” in the formula F4 indicates a large one of zero (o) and {f(room temperature)+f(solar radiation amount)+f(seat heater)}.

As mentioned in the description of control step S1121, as the vehicle interior temperature Tr becomes higher, the value f (room temperature) is determined to be larger. As the vehicle interior temperature Tr becomes higher, the engine ON request suppression time f (environment) becomes longer.

As mentioned in the description of control step S1122, as the solar radiation amount Ts becomes more, the value f(solar radiation amount) is determined to be larger. As the solar radiation amount Ts becomes more, the engine ON request suppression time f (environment) becomes longer.

As mentioned in the description of control step S1123, when the seat air conditioner 90 is operating (when the seat heater is turned ON), the value f(seat heater) is determined to be large as compared to when the seat air conditioner 90 is not operating (when the seat heater is turned OFF). Thus, when the seat air conditioner 90 is operating (when the seat heater is turned ON), the engine ON request suppression time f(environment) is made long as compared to when the seat air conditioner 90 is not operating (when the seat heater is turned OFF).

In step S1107 and the following steps, the same processes as those of the first embodiment (see FIGS. 8 and 9) are performed.

In this embodiment, as mentioned in the description of control steps S1121 and S1126, the value f(room temperature) is determined such that as the vehicle interior temperature Tr detected by the inside air sensor 51 serving as the vehicle-interior temperature detection means becomes higher, the engine ON request suppression time f(environment) is made longer.

Thus, as the vehicle interior temperature Tr becomes higher, the air conditioner for the vehicle of this embodiment can more suppress the operation of the internal combustion engine EG for increasing the coolant temperature at the startup of the vehicle. When the required heating capacity is small, the operation of the internal combustion engine EG for increasing the coolant temperature at the startup of the vehicle can be suppressed effectively.

In this embodiment, as mentioned in the description of control steps S1122 and S1126, the value f(solar radiation amount) is determined such that as the solar radiation amount Ts detected by the solar radiation sensor 53 serving as a solar radiation amount detection means becomes larger, the engine ON request suppression time f(environment) is made longer.

That is, as the solar radiation amount Ts becomes larger, the air conditioner for the vehicle of this embodiment can more suppress the operation of the internal combustion engine EG for increasing the coolant temperature at the startup of the vehicle. When the required heating capacity is small, the operation of the internal combustion engine EG for increasing the coolant temperature at the startup of the vehicle can be suppressed more effectively.

In this embodiment, as mentioned in the description of control steps S1123 and S1126, when the seat air conditioner 90 serving as an auxiliary heating means is operating (when the seat heater is turned ON), the engine ON request suppression time f(environment) is made long as compared to when the seat air conditioner 90 is not operating (when the seat heater is turned OFF).

Thus, when the seat air conditioner 90 is operating, the air conditioner for the vehicle of this embodiment can more suppress the operation of the internal combustion engine EG for increasing the coolant temperature at the startup of the vehicle. Further, when the seat air conditioner 90 is operating, the air conditioner for the vehicle can make the passenger feel sufficiently warm even though the temperature of air blown into the vehicle interior is low. Thus, the operation of the internal combustion engine EG that might increase the coolant temperature can be suppressed at startup of the vehicle without removing the warmth from the passenger.

### Third Embodiment

In the second embodiment, when the vehicle startup time does not reach the engine ON request suppression time f(environment), the engine OFF water temperature Twoff can be set to a low temperature to thereby suppress the operation of the internal combustion engine EG. On the other hand, in a third embodiment, when the startup time of the vehicle does not reach the engine ON request suppression time f(environment), the operation of the internal combustion engine EG is prohibited regardless of the engine OFF water temperature Twoff.

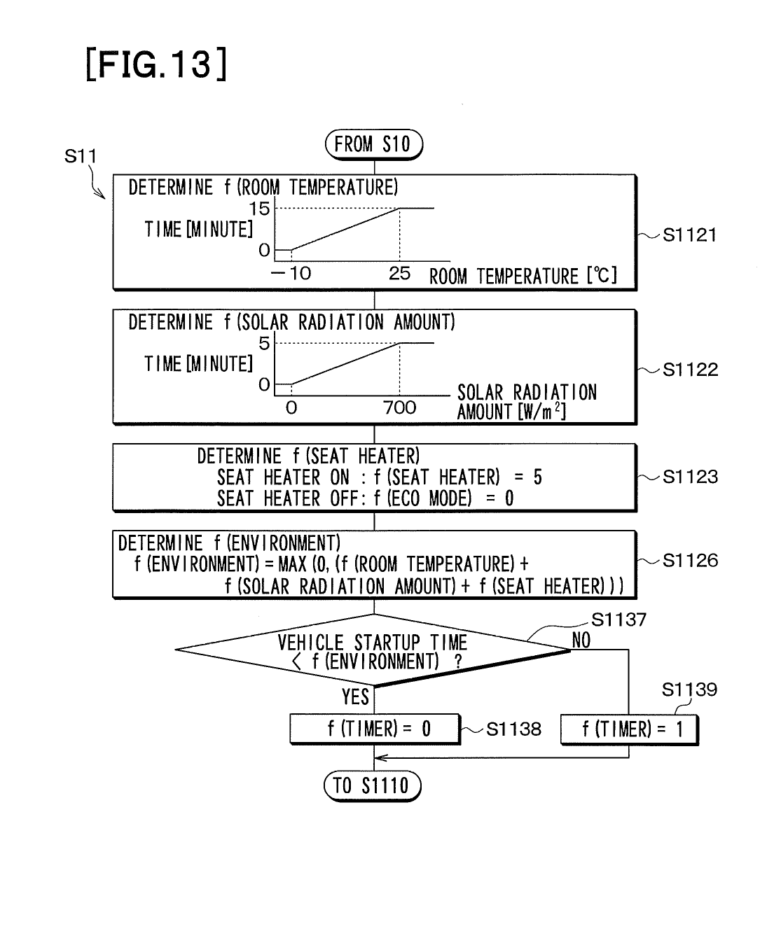

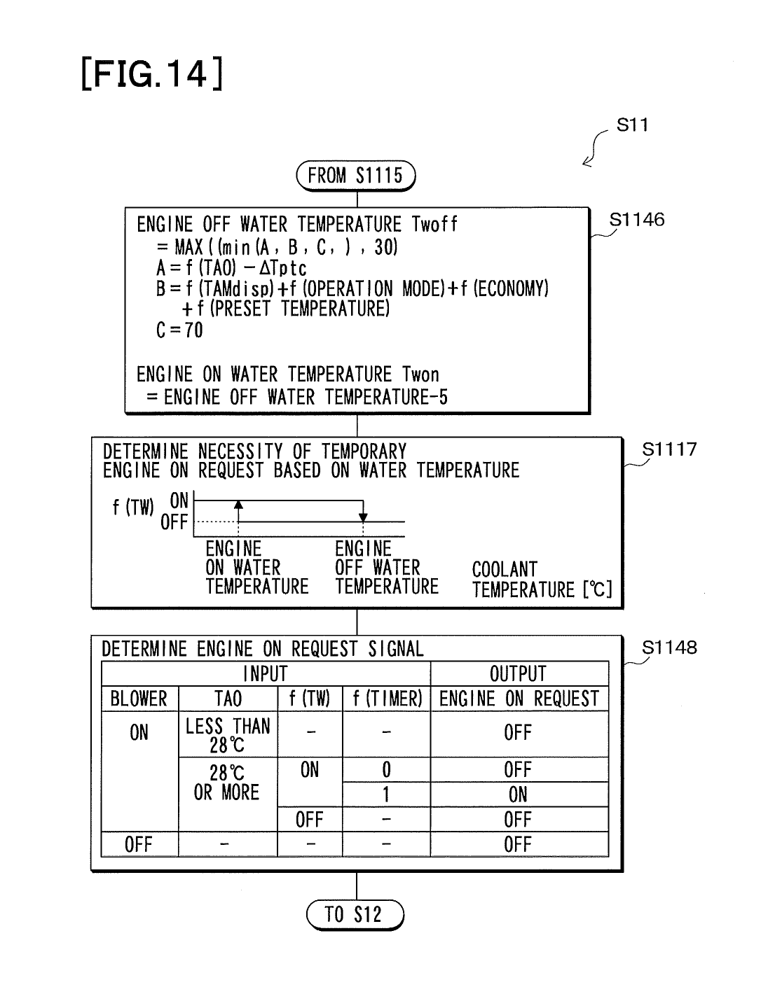

FIGS. 13 and 14 show the flowcharts for explaining the details of the process of step S11 in this embodiment. The steps S1121 to S1126 shown in FIG. 13 are the same as those of the second embodiment.

In subsequent step S1137, it is determined whether or not the vehicle startup time reaches the engine ON request suppression time f(environment) determined in step S1126. When the vehicle startup time does not reach the engine ON request suppression time f(environment) (if YES), the operation proceeds to step S1138. In S1138, a temporary request signal flag f(TIMER) indicates of whether the operation request signal or operation stopping signal of the internal combustion engine EG is output or not is set to zero (0) (f(TIMER)=0). Then, the operation proceeds to step S1110.

When the vehicle startup time reaches the engine ON request suppression time f (environment) (if NO) in step S1137, the operation proceeds to step S1139, in which the temporary request signal flag f(TIMER) is set to 1 (f(TIMER)=1), and then the operation proceeds to step S1110.

The subsequent steps S1110 to S1115 are the same as those of the first and second embodiments (see FIG. 8).

Then, in step S1146 shown in FIG. 14, the engine ON water temperature Twon and engine OFF water temperature Twoff are determined which serve as determination thresholds used for determining whether or not the operation request signal or operation stopping signal of the internal combustion engine EG is output based on the coolant temperature Tw. The engine ON water temperature Twon is a coolant temperature Tw serving as a criterion for judgment regarding whether the stopping request signal is output or not. The engine OFF water temperature Twoff is a coolant temperature Tw serving as a criterion for judgment regarding whether the operation stopping signal of the internal combustion engine EG is output or not.

That is, the engine OFF water temperature Twoff is the upper limit temperature at which the driving force controller 70 operates the internal combustion engine EG to increase the coolant temperature Tw. That is, the driving force controller 70 continues operating the internal combustion engine EG until the coolant temperature Tw reaches the engine OFF water temperature Twoff in increasing the coolant temperature Tw. Thus, the control step S1146 of this embodiment serves as an upper limit temperature determination means.

Specifically, the engine OFF water temperature Twoff is determined by the following method. As shown in step S1146 of FIG. 14, the method involves comparing a temperature of 30° C. with a smallest one of a temperature of 70° C., a value obtained by subtracting the increase in temperature ΔTptc of blown air from the target coolant temperature f(TAO), and a value obtained by adding the operation mode correction term f(operation mode), the economy correction term f(economy), and the preset temperature correction term f(preset temperature) to the temporary upper limit temperature f(TAMdisp); and then selecting a larger one of the above smallest value and the temperature of 30° C., as the engine OFF water temperature Twoff.

In step S1146, the value obtained by subtracting the blown air temperature increase Tptc from the target coolant temperature f(TAO) (indicated by reference numeral “A” of step S1146 shown in FIG. 14) is a value that is produced by subtracting the increase in temperature for operating the PTC heaters 37 from the desired coolant temperature Tw that allows the air conditioner 1 for the vehicle to exhibit the sufficient heating capacity. The setting of the above temperature as the engine OFF water temperature Twoff surely allows the air conditioner 1 to exhibit the sufficient heating capacity.

The value obtained by adding the respective correction terms f(operation mode), f(economy), and f(preset temperature) to the temporary upper limit temperature f(TAMdisp) (“B” of step S1146 of FIG. 14) is a value provided by correcting the coolant temperature Tw formed not to increase the frequency of the unnecessary operation of the internal combustion engine EG, based on the operation mode, the on/off state of the economy switch, and the target vehicle interior temperature Tset. The setting of the above temperature as the engine OFF water temperature Twoff can suppress the increase in frequency of the operation of the internal combustion engine EG.

Then, the temperature of 70° C. (“C” of step S1146 of FIG. 14) is the same as the maximum value of the temporary upper limit temperature f (TAMdisp) determined in step S1112, and is a value determined as a protective value for surely outputting the operation stopping signal of the engine.

Thus, by employing the lowest one among these temperatures, the engine OFF water temperature TWoff can be determined to be the desired coolant temperature Tw that allows the air conditioner for the vehicle to exhibit the high heating capacity, or the coolant temperature Tw that does not increase the frequency of operation of the internal combustion engine EG.

The smallest value among these temperatures described above is compared with 30° C. determined as the lower limit of value which surly outputs the operation stopping signal of the engine, and then the bigger one of them is determined as the engine OFF water temperature Twoff, which can surely prevent the operation of the internal combustion engine EG from continuing due to the request from the air conditioner 1 for the vehicle.

In contrast, the engine ON water temperature Twon is set lower by a predetermined value (in this embodiment, 5° C.) than the engine OFF water temperature Twoff so as to suppress frequent ON/OFF of the engine. The predetermined value is set as a hysteresis width for preventing the control hunting.

In subsequent step S1117, like the first embodiment (see FIG. 9), a temporary request signal flag f(TW) indicative of whether the operation request signal or operation stopping signal of the internal combustion engine EG is output or not is determined according to the coolant temperature Tw. Specifically, when the coolant temperature Tw is lower than the engine ON water temperature Twon determined in step S1116, the temporary request signal flag f(Tw) is set to on (f(Tw)=ON), whereby the operation request signal of the internal combustion engine EG is temporarily determined to be output. When the coolant temperature Tw is higher than the engine OFF water temperature Twoff, the temporary request signal flag f(Tw) is set to off (f(Tw)=OFF), whereby the operation stopping request signal of the engine EG is temporarily determined to be output.

In subsequent step S1148, a request signal to be output to the driving force controller 7 is determined based on the operating state of the blower 32, the target outlet air temperature TAO, the temporary request signal flag f(Tw), and f(TIMER) with reference to the control map previously stored in the air conditioning controller 50. Then, the operation proceeds to step S12 shown in FIG. 4.

Specifically, in step S1148, when the blower 32 is operating and the target outlet air temperature TAO is less than 28° C., the request signal for stopping the internal combustion engine EG is determined regardless of the temporary request signal flag f(Tw) and f(TIMER).

While the blower 32 is operating and the target outlet air temperature TAO is equal to or more than 28° C., the request signal for stopping the internal combustion engine EG is determined when the temporary request signal flag f(Tw) is ON and the temporary request signal flag f(TIMER) is zero (0). Alternatively, the request signal for operating the internal combustion engine EG is determined when the temporary request signal flag f(Tw) is ON and the temporary request signal flag(TIMER) is 1. Further, when the temporary request signal flag f(Tw) is OFF, the request signal for stopping the engine EG is determined regardless of the temporary request signal f(TIMER).

When the blower 32 is not operated, the request signal for stopping the internal combustion engine EG is determined regardless of the target outlet air temperature TAO, the temporary request signal flag f(Tw), and f(TIMER).

As mentioned in the description of the control step S1138, when the vehicle startup time does not reach the engine ON request suppression time f(environment), the temporary request signal flag f(TIMER) is set to zero (0) (TIMER)=0). In this case, the request signal for stopping the internal combustion engine EG is determined regardless of the operating state of the blower 32 and the target outlet air temperature TAO, which can prohibit the output of the request signal for operating the internal combustion engine EG. Thus, the process in step S1148 serves as a suppression means for suppressing the output of the request signal from the request signal output means 50a to the driving force controller 70.

In this embodiment, when the vehicle startup time does not reach the engine ON request suppression time f(environment), the request signal to be output to the driving force controller 70 is determined to be the request signal for stopping the internal combustion engine EG regardless of the engine OFF water temperature Twoff. Thus, this embodiment can surely suppress the operation of the internal combustion engine EG for increasing the coolant temperature at the startup of the vehicle.

### Fourth Embodiment

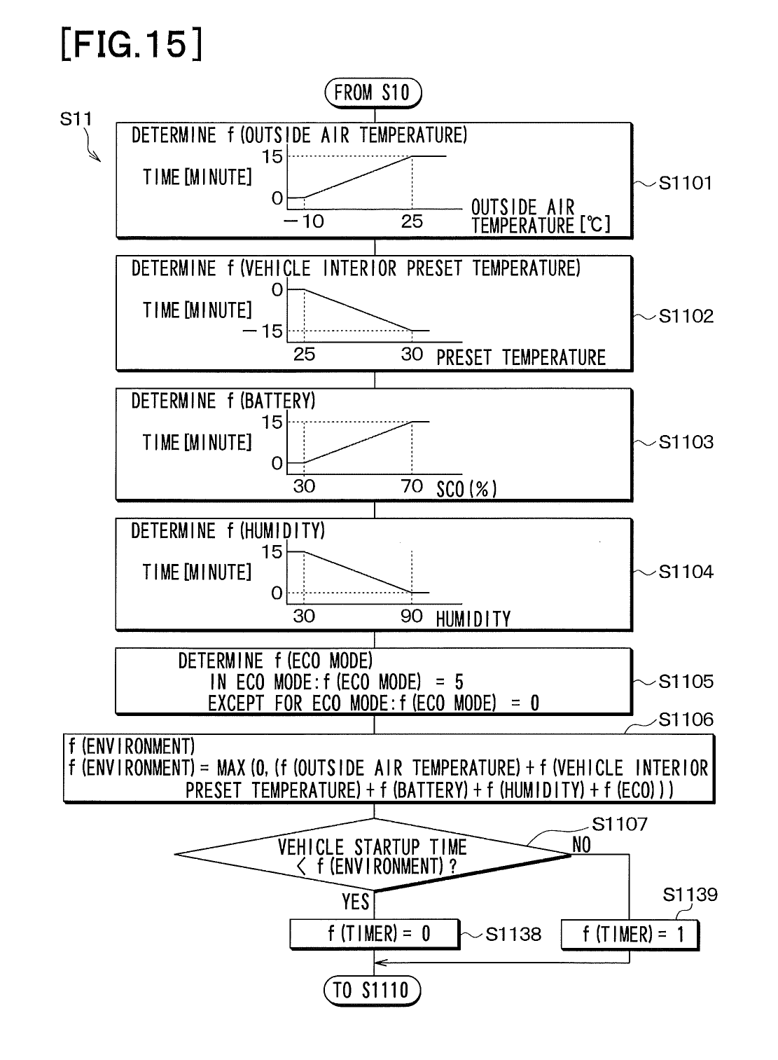

A fourth embodiment of the invention is provided by changing the steps S1108 and S1109 of the first embodiment (see FIG. 7) to the steps S1138 and S1139 of the third embodiment (see FIG. 13) as shown in FIG. 15.

Like the third embodiment, in this embodiment, when the vehicle startup time does not reach the engine ON request suppression time f(environment), the control step S1148 as the request suppression means determines the request signal for stopping the internal combustion engine EG as the request signal to be output to the driving force controller 70, regardless of the engine OFF water temperature Twoff, which can surely suppress the operation of the internal combustion engine EG for increasing the coolant temperature at the startup of the vehicle.

### Fifth Embodiment

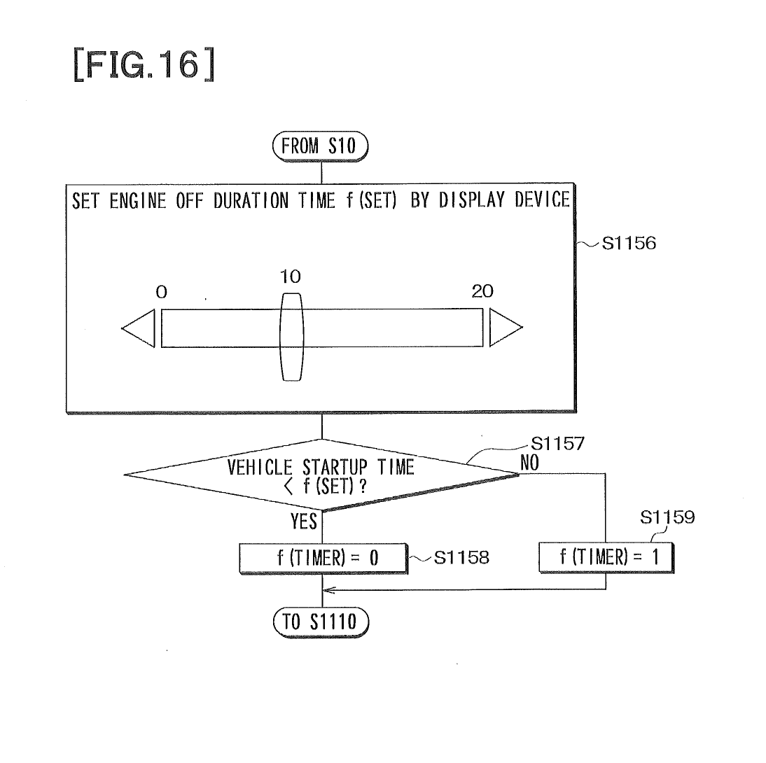

In the third and fourth embodiments, the engine ON request suppression time f(environment) is determined according to environmental conditions, including the outside air temperature Tam, the vehicle interior preset temperature Tset, the remaining storage level SOC of the battery 81, the relative humidity of the vehicle interior air, the selection state of the eco mode, the interior air temperature Tr, the solar radiation amount Ts, and the operating state of the seat air conditioner 90. However, in a fifth embodiment, as shown in FIG. 16, the engine ON request suppression time is determined based on the time set by the passenger.

In step S1156, first, the time f(SET) set by the passenger is read. The time f(SET) is a time (engine OFF duration time) during which the state OFF of the engine is requested by the passenger to be continued after the startup of the vehicle.

In this embodiment, specifically, in step S1156 shown in FIG. 16, a setting screen for an engine OFF duration time f(SET) is displayed on a display device. The engine OFF duration time f(SET) can be set by the user's touching the setting screen. The display device serves as a time setting means of setting the time by the passenger's operation.

In subsequent step S1157, it is determined whether or not the vehicle startup time reaches the engine ON request suppression time. In this embodiment, specifically, in step S1157 shown in FIG. 16, it is determined whether or not the vehicle startup time reaches the engine OFF duration time f(SET) read in step S1156. That is, in this embodiment, the engine ON request suppression time is set to the same value as the engine OFF duration time f(SET) set by the passenger. The engine ON request suppression time may be determined by correcting the engine OFF duration time f(SET).

When the vehicle startup time does not reach the engine ON request suppression time f(SET) (if YES), the operation proceeds to step S1158, in which the temporary request signal flag f(TIMER) indicative of whether the operation request signal or operation stopping signal of the internal combustion engine EG is output or not is set to zero (0) (f(TIMER)=0). Then, the operation proceeds to step S1110.

When the vehicle startup time reaches f(SET) in step S1157 (if NO), the operation proceeds to step S1159, in which the temporary request signal flag f(TIMER) is set to 1 (f(TIMER)=1). Then, the operation proceeds to step S1110.

In step S1110 and the following steps, the same processes as those of the third and fourth embodiments are performed. That is, after execution of steps S1110 to S1115 shown in FIG. 8, steps S1146 to S1148 shown in FIG. 14 are performed.

In this embodiment, as the engine OFF duration time f(SET) set by the passenger's operation becomes longer, the engine ON request suppression time becomes longer, so that the operation of the internal combustion engine EG for increasing the coolant temperature can be suppressed at startup of the vehicle. Thus, the operation of the engine EG for increasing the coolant temperature can be surely suppressed at the startup of the vehicle according to the passenger's request.

### Sixth Embodiment

In the first and second embodiments, when the vehicle startup time reaches the engine ON request suppression time f(environment), the engine OFF water temperature Twoff becomes large as compared to when the vehicle startup time does not reach the engine ON request suppression time f(environment). However, in the sixth embodiment, the engine OFF water temperature Twoff gradually increases during the startup of the vehicle as the time has elapsed.

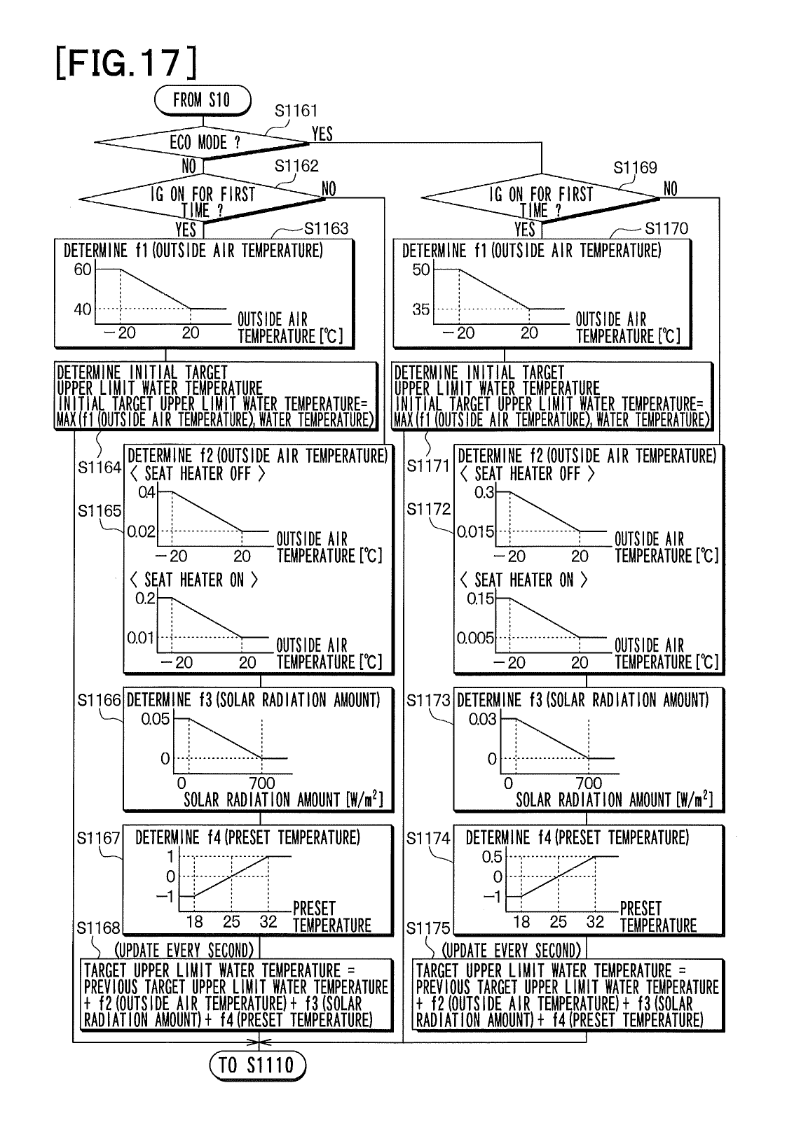

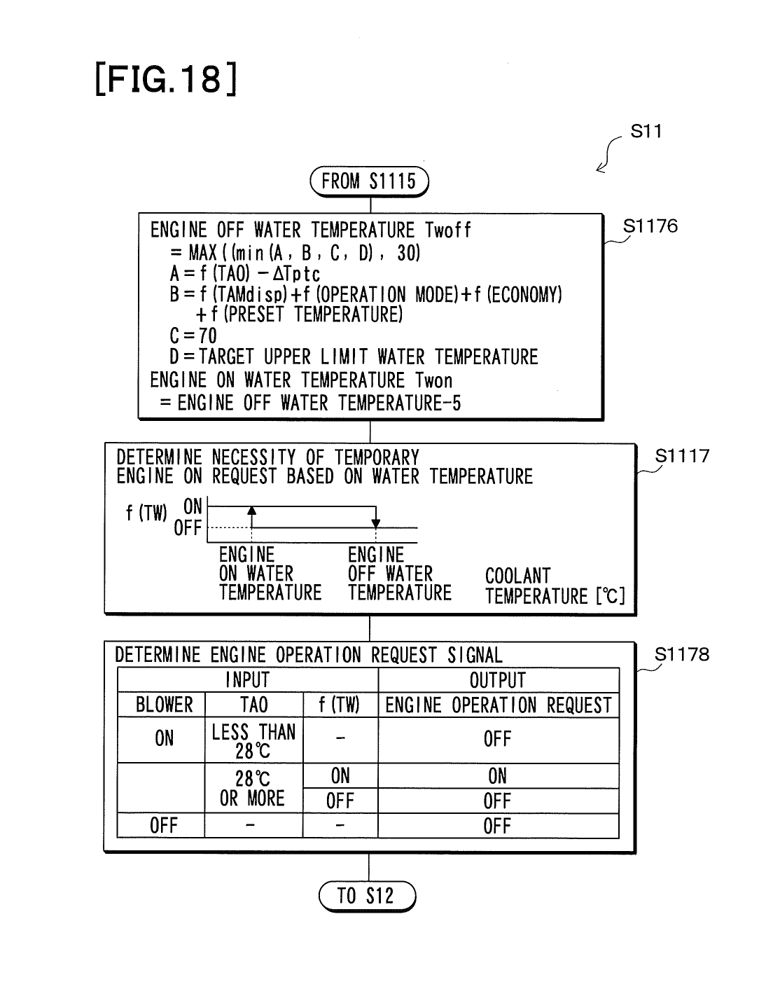

FIGS. 17 and 18 show the flowcharts for explaining the details of the process of step S11 in this embodiment. In steps S1161 to S1175 shown in FIG. 17, the target upper limit of water temperature is determined at regular intervals. Thus, the processes in step S1161 to S1175 serve as the target upper limit water temperature determination means.

The target upper limit water temperature is a value determined to suppress the operation of the internal combustion engine EG at startup of the vehicle. That is, the target upper limit water temperature is the engine OFF water temperature Twoff at the startup of the vehicle.

More specifically, in steps S1161 to S1175, the target upper limit water temperature is determined such that the engine OFF water temperature Twoff gradually increases during the startup of the vehicle as the time has elapsed, as will be mentioned later in the description of the step S1176.

Specifically, first, in step S1161, it is determined whether the air conditioner is in the eco mode or not (whether the economy switch is turned on (ON) or not). When the economy switch is not turned on and the present state is not in the eco mode (if NO), the processes in steps S1162 to S1168 are performed to determine the target upper limit water temperature in states other than the eco mode. In contrast, when the economy switch is turned on and the air conditioner is in the eco mode (if YES), the processes in steps S1169 to S1175 are performed to determine the target upper limit water temperature in the eco mode.

The processes in steps S1162 to S1168 will be specifically described below. First, in step S1162, it is determined whether the target upper limit water temperature is determined for the first time or not (IG ON first time) after the startup of the vehicle. When the determination of the target upper limit water temperature is determined to be performed for the first time (if YES), the processes in steps S1163 and S1164 are performed to determine an initial target upper limit water temperature.

In step S1163, first, a value f1 (outside air temperature) is determined based on the outside air temperature Tam detected by the outside air temperature sensor 52 with reference to the control map previously stored in the air conditioning controller 50. The value f1(outside air temperature) is a value used to determine the initial target upper limit water temperature.

In this embodiment, specifically, in step S1163 shown in FIG. 17, as the outside air temperature Tam becomes higher, the value f1 (outside air temperature) is determined to be smaller.

In subsequent step S1164, the initial target upper limit water temperature is determined based on the value f1 (outside air temperature) determined in step S1163 and the coolant temperature Tw detected by the coolant temperature sensor 58, and the operation proceeds to step S1110. Specifically, the initial target upper limit water temperature is determined by the following mathematical formula F5.

Initial Target Upper Limit Water Temperature=MAX{f1(outside air temperature), water temperature} (F5)

in which the water temperature in the formula 5 is the coolant temperature Tw detected by the coolant temperature sensor 58, and the Max {f1 (outside air temperature), water temperature} in the formula F3 means a larger one of the water temperature and the f1(outside air temperature). That is, the initial target upper limit water temperature is determined to be a value higher than the coolant temperature Tw directly after the startup of the vehicle.

As mentioned in the description of the control step S1163, as the outside air temperature Tam becomes lower, the value f1 (outside air temperature) is determined to be smaller. Thus, as the outside air temperature Tam becomes higher, the initial target upper limit water temperature becomes lower.

When the determination of the target upper limit water temperature is determined not to be performed for the first time in step S1162 (if NO), the processes in steps S1165 and S1168 are performed to determine the target upper limit water temperature for the second time or later.

Specifically, in step S1165, the value f2(outside air temperature) is determined based on the outside air temperature Tam detected by the outside air temperature sensor 52 with reference to the control map previously stored in the air conditioning controller 50. The value f2(outside air temperature) is a value used to determine the target upper limit water temperature for the second time or later.

In this embodiment, specifically, in step S1165 shown in FIG. 17, as the outside air temperature Tam becomes higher, the value f2(outside air temperature) is determined to be smaller. When the seat air conditioner 90 is operating (when the seat heater is turned ON), the value f2(outside air temperature) is determined to be small as compared to when the seat air conditioner 90 is not operating (when the seat heater is turned OFF).

In subsequent step S1166, the value f3(solar radiation amount) is determined based on the solar radiation amount Ts of the vehicle interior detected by the solar radiation sensor 53 with reference to the control map previously stored in the air conditioning controller 50. The value f3(solar radiation amount) is a value used to determine the target upper limit water temperature for the second time or later.

In this embodiment, specifically, in step S1166 shown in FIG. 17, as the solar radiation amount Ts becomes more, the value f3 (solar radiation amount) is determined to be smaller.

In subsequent step S1167, the value f4(preset temperature) is determined based on the vehicle interior preset temperature Tset set by the vehicle interior temperature setting switch of the operation panel 60 with reference to the control map previously stored in the air conditioning controller 50. The value f4(preset temperature) is a value used to determine the target upper limit water temperature for the second time or later.

In this embodiment, specifically, in step S1167 shown in FIG. 17, as the interior preset temperature Tset becomes higher, the value f4(preset temperature) is determined to be larger.

In subsequent step S1168, the target upper limit water temperature for the second time or later is determined based on the value f2(outside air temperature), value f3 (solar radiation amount), and value f4(preset temperature) determined in steps S1165 to S1167. Then, the operation proceeds to step S1110. Specifically, the target upper limit water temperature for the second time or later is determined by the following mathematical formula F6:

Target Upper Limit Water Temperature=Previous Target Upper Limit Water Temperature+f2(outside air temperature)+f3(solar radiation amount)+f4(preset temperature) (F6)

The target upper limit water temperature is updated at regular intervals (every one second in this embodiment). That is, every time the target upper limit water temperature is updated, the value f2(outside air temperature), the value f3(solar radiation amount), and the value f4(preset temperature) are added to the previous target upper limit water temperature, which can gradually increase the target upper limit water temperature as the time has elapsed.

In this embodiment, when the vehicle interior preset temperature Tset is low, the value f4(preset temperature) is set to a minus value, which suppresses the increase in target upper limit water temperature. In other words, when the strong heating is not desired by the passenger, the operation of the internal combustion engine EG is suppressed.

As mentioned in the description of control step S1164, as the outside air temperature Tam becomes higher, the initial target upper limit water temperature is determined to be lower. Thus, as the outside air temperature Tam becomes higher, the target upper limit water temperature for the second time or later becomes lower.

As mentioned in the description of control step S1164, the initial target upper limit water temperature is determined to be equal to or higher than the coolant temperature Tw directly after the startup of the vehicle. Thus, as the coolant temperature Tw becomes higher directly after the startup of the vehicle, the target upper limit water temperature for the second time or later becomes higher.

As mentioned in the description of the control step S1165, as the outside air temperature Tam becomes higher, the value f2 (outside air temperature) is determined to be smaller. Thus, as the outside air temperature Tam becomes higher, the target upper limit water temperature for the second time or later becomes lower.

As mentioned in the description of control step S1165, when the seat air conditioner 90 is operating (when the seat heater is turned ON), the value f2(outside air temperature) is determined to be small as compared to when the seat air conditioner 90 is not operating (when the seat heater is turned OFF). When the seat air conditioner 90 is operating (when the seat heater is turned ON), the target upper limit water temperature for the second time or later becomes lower as compared to when the seat air conditioner 90 is not operating (when the seat heater is turned OFF).

As mentioned in the description of control step S1166, as the solar radiation amount Ts becomes higher, the value f3 (solar radiation amount) is determined to be smaller. As the solar radiation amount Ts becomes higher, the target upper limit water temperature for the second time or later becomes lower.

As mentioned in the description of control step S1167, as the vehicle interior preset temperature Tset becomes higher, the value f4 (preset temperature) is determined to be larger. As the interior preset temperature Tset becomes higher, the target upper limit water temperature for the second time or later becomes higher.

In the way above, the target upper limit water temperature in states other than the eco mode is determined throughout steps S1162 to S1168.

When the eco mode is determined in step S1161 (if YES), the processes in steps S1169 to S1175 are also the same as those of steps S1162 to S1168. The target upper limit water temperature in the eco mode determined in steps S1169 to S1175 can gradually increase as the time has elapsed, in the same way as the target upper limit water temperature in states other than the eco mode determined in steps S1162 to S1168.

In steps S1170, and S1172 to S1174, the value f1(outside air temperature), the value f2(outside air temperature), the value f3(solar radiation amount), and the value f4(preset temperature) are determined to be small as compared to those in steps S1163, and S1165 to S1167. Thus, in steps S1171 and S1175, the initial target upper limit water temperature and the target upper limit water temperatures for the second time or later are determined to be small as compared to those in steps S1164 and S1168. That is, in the cco mode, the target upper limit water temperature is small as compared to that in states other than the eco mode.

In this embodiment, specifically, like step S1163, in step S1170, as the outside air temperature Tam becomes higher, the value f1(outside air temperature) is determined to be smaller. As the outside air temperature Tam becomes higher, the initial target upper limit water temperature becomes lower, and also the target upper limit water temperature for the second time or later becomes lower.

In step S1171, like step S1164, the initial target upper limit water temperature is determined to be equal to or more than the coolant water temperature Tw directly after the startup of the vehicle. Thus, as the coolant temperature Tw becomes higher directly after the startup of the vehicle, the target upper limit water temperature for the second time or later becomes higher.

In step S1172, like step S1165, as the outside air temperature Tam becomes higher, the target upper limit water temperature becomes lower. Thus, as the outside air temperature Tam becomes higher, the target upper limit water temperature for the second time or later becomes lower.

In step S1172, like step S1165, when the seat air conditioner 90 is operating (when the seat heater is turned ON), the target upper limit water temperature becomes lower as compared to when the seat air conditioner 90 is not operating (when the seat heater is turned OFF). Thus, when the seat air conditioner 90 is operating (when the seat heater is turned ON), the target upper limit water temperature for the second time or later becomes lower as compared to when the seat air conditioner 90 is not operating (when the seat heater is turned OFF).

In step S1173, like step S1166, as the solar radiation amount Ts becomes large, the target upper limit water temperature becomes smaller. As the solar radiation amount Ts becomes larger, the target upper limit water temperature for the second time or later becomes lower.

In step S1174, like step S1164, as the interior preset temperature Tset becomes higher, the target upper limit water temperature becomes higher. As the interior preset temperature Tset becomes higher, the target upper limit water temperature for the second time or later becomes higher.

In subsequent steps S1110 to S1115, the same processes as those of the first embodiment (see FIG. 8) are performed. After the process in step S1115, the operation proceeds to the step S1176 shown in FIG. 18. Then, in step S1176, the engine ON water temperature Twon and the engine OFF water temperature Twoff are determined as determination thresholds which are used to determine whether an operation request signal or operation stopping signal of the internal combustion engine EG is output or not based on the coolant temperature Tw. The engine ON water temperature Twon is a coolant temperature Tw serving as a criterion for judgment regarding whether the stopping request signal is output or not. The engine OFF water temperature Twoff is a coolant temperature Tw serving as a criterion for judgment regarding whether the operation stopping signal of the internal combustion engine EG is output or not.

That is, the engine OFF water temperature Twoff is the upper limit temperature at which the driving force controller 70 operates the internal combustion engine EG to increase the coolant temperature Tw. That is, in increasing the coolant temperature Tw, the driving force controller 70 operates the internal combustion engine EG until the coolant temperature Tw reaches the engine OFF water temperature Twoff. Thus, the control step S1176 of this embodiment serves as an upper limit temperature determination means.

Specifically, the engine OFF water temperature Twoff is determined by the following method. As shown in step S1176 of FIG. 18, the method involves comparing a temperature of 30° C. with a smallest one of a temperature of 70° C., the target upper limit of water temperature, a value obtained by subtracting the increase in temperature ΔTpt of blown air from the target coolant temperature f(TAO), and a value obtained by adding the operation mode correction term f(operation mode), the economy correction term f(economy), and the preset temperature correction term f(preset temperature) to the temporary upper limit temperature f(TAMdisp); and then selecting a larger one of the above smallest value and the temperature of 30° C., as the engine OFF water temperature Twoff.

In step S1176, the value obtained by subtracting the blown air temperature increase ΔTptc from the target coolant temperature f(TAO) (indicated by reference numeral “A” of step S1176 shown in FIG. 18) is a value that is produced by subtracting the increase in temperature caused by operating the PTC heaters 37 from the desired coolant temperature Tw that allows the air conditioner 1 for the vehicle to exhibit the sufficient heating capacity. The setting of the above temperature as the engine OFF water temperature Twoff surely allows the air conditioner 1 for the vehicle to exhibit the sufficient heating capacity.

Then, the value obtained by adding the respective correction terms f(operation mode), f(economy), and f(preset temperature) to the temporary upper limit temperature f(TAMdisp) (“B” of step S1176 of FIG. 18) is a value provided by correcting the coolant temperature Tw formed not to increase the frequency of the unnecessary operation of the internal combustion engine EG, based on the operation mode, the on/off state of the economy switch, and the target vehicle interior temperature Tset. The setting of the above temperature as the engine OFF water temperature Twoff can suppress the increase in frequency of the operation of the internal combustion engine EG.

Then, the temperature of 70° C. (“C” of step S1176 shown in FIG. 18) is the same as the maximum temporary upper limit temperature f(TAMdisp) determined in step S1112. In other words, the temperature of 70° C. is a value determined for protection to surely output the operation stopping signal of the engine.

After the startup of the vehicle, the target upper limit water temperature (“D” of step S1176 shown in FIG. 18) gradually increases as the time has elapsed. The setting of the above temperature as the engine OFF water temperature Twoff can suppress the operation of the internal combustion engine EG at the startup of the vehicle.

By selecting the smallest one of the above temperatures as the engine OFF water temperature Twoff, the engine OFF water temperature Twoff can be determined to be the desired coolant temperature Tw that allows the air conditioner for the vehicle to exhibit the high heating capacity, or the coolant temperature Tw that does not increase the frequency of operation of the internal combustion engine EG. In particular, when the target upper limit water temperature becomes the smallest value at the startup of the vehicle, the engine OFF water temperature Twoff at the startup can also be determined to be small, which can suppress the operation of the internal combustion engine EG.

The smallest value described above is compared with 30° C. determined as the lower limit of value which surely outputs the operation stopping signal of the engine, and then the bigger one of them is determined as the engine OFF water temperature Twoff, which can surely prevent the operation of the internal combustion engine EG from continuing due to the request from the air conditioner 1 for the vehicle.

In contrast, the engine ON water temperature Twon is set lower by a predetermined value (in this embodiment, 5° C.) than the engine OFF water temperature Twoff so as to prevent the frequent ON/OFF of the engine. The predetermined value is set as a hysteresis width for preventing the control hunting.

In subsequent step S1117, like the first embodiment (see FIG. 9), a temporary request signal flag f(TW) indicative of whether the operation request signal or operation stopping signal of the internal combustion engine EG is output or not is determined according to the coolant temperature Tw. Specifically, when the coolant temperature Tw is lower than the engine ON water temperature Twon determined in step S1116, the temporary request signal flag f(Tw) is set to on (f(Tw)=ON), whereby the operation request signal of the internal combustion engine EG is temporarily determined to be output. When the coolant temperature Tw is higher than the engine OFF water temperature Twoff, the temporary request signal flag f(Tw) is set to off (f(Tw)=OFF), whereby the operation stopping signal of the internal combustion engine EG is temporarily determined to be output.

In subsequent step S1178, the request signal to be output to the driving force controller 70 is determined based on the operating state of the blower 32, the target outlet air temperature TAO, and the temporary request signal flag f(Tw) with respect to the control map previously stored in the air conditioning controller 50. Then, the operation proceeds to step S12 shown in FIG. 4.

Specifically, in step S1178, when the blower 32 is operating and the target outlet air temperature TAO is less than 28° C., the request signal for stopping the internal combustion engine EG is determined regardless of the temporary request signal flag f(Tw).

When the blower 32 is operating and the target outlet air temperature TAO is equal to or more than 28° C., the request signal for operating the internal combustion engine EG is determined in turning on the temporary request signal flag f(Tw), or the request signal for stopping the internal combustion engine EG is determined in turning off the temporary request signal flag f(Tw). When the blower 32 is not operating, the request signal for stopping the internal combustion engine EG is determined regardless of the target outlet air temperature TAO and the temporary request signal flag f(Tw).

As mentioned in the description of the control step S1176, the target upper limit water temperature gradually increases as the time has elapsed since the startup of the vehicle, and can be set to a small value at the startup. Thus, when the engine OFF water temperature Twoff is determined to be the target upper limit water temperature at startup of the vehicle, the temporary request signal flag f(Tw) tends to be turned OFF, and the request signal for stopping the internal combustion engine EG is apt to be determined, which suppresses the output of the request signal for operating the internal combustion engine EG. Thus, the process in step S1178 serves as a suppression means for suppressing the output of the request signal from the request signal output means 50a to the driving force controller 70.

In the air conditioner 1 for the vehicle of this embodiment, as mentioned in the description of control steps S1168, S1175, and S1176, the control step S1176 serving as the upper limit temperature determination means determines the target upper limit of water temperature such that the engine OFF water temperature Twoff gradually increases as the time has elapsed at the startup of the vehicle.

Thus, during the startup of the vehicle, the engine OFF water temperature Twoff becomes small and the coolant temperature Tw tends to reach the engine OFF water temperature Twoff, which suppresses the request signal output means 50a from outputting the engine ON request signal to the driving force control means 70. That is, at the startup (warming-up initial stage) of the vehicle, the air conditioner for the vehicle of this embodiment can suppress the operation of the internal combustion engine EG for increasing the coolant temperature.

Also, the air conditioner for the vehicle of this embodiment can suppress the passenger from feeling uncomfortable due to the operation of the engine while the battery is nearly fully charged. Further, the air conditioner for the vehicle can effectively use the charged power for traveling to thereby improve the fuel efficiency of the vehicle. The operation of the internal combustion engine EG can be suppressed to reduce vehicle exterior noise.

Since the engine OFF water temperature Twoff increases as the time has elapsed, the internal combustion engine EG can be more easily operated as time goes by. Thus, this embodiment can improve the heating capacity to thereby make the passenger feel warmer as the time has elapsed.

In this embodiment, as mentioned in the description of control steps S1168, S1175, and S1176, the target upper limit water temperature is determined such that as the outside air temperature Tam detected by the outside air temperature sensor 52 serving as the outside air temperature detection means becomes higher, the engine OFF water temperature Twoff becomes lower at the startup of the vehicle.

That is, as the outside air temperature Tam becomes higher, the air conditioner for the vehicle of this embodiment can more effectively suppress the operation of the internal combustion engine EG that might increase the coolant temperature at the startup of the vehicle. When the required heating capacity is small, the operation of the internal combustion engine EG that increases the coolant temperature at the startup of the vehicle can be suppressed more effectively.

In this embodiment, however, as mentioned in the description of control steps S1164 and S1171, as the outside air temperature Tam becomes higher, the initial target upper limit water temperature is determined to be smaller. As the outside air temperature Tam becomes higher, the engine OFF water temperature Twoff determined first after the startup of the vehicle becomes lower. Even though the engine OFF water temperature Twoff gradually increases thereafter, the engine OFF water temperature Twoff can be kept to a lower level.

That is, as the outside air temperature Tam becomes higher, the air conditioner for the vehicle of this embodiment can effectively suppress the operation of the internal combustion engine EG for increasing the coolant temperature at the startup of the vehicle. When the required heating capacity is small, the operation of the internal combustion engine EG for increasing the coolant temperature can be effectively suppressed at the startup of the vehicle.

In steps S1164 and S1171, as the vehicle indoor temperature Tr becomes higher, the initial target upper limit water temperature may be made lower. In this case, as the vehicle interior air temperature Tr becomes higher, the engine OFF water temperature Twoff determined first after the startup of the vehicle becomes smaller. Even though the engine OFF water temperature Twoff gradually increases thereafter, the engine OFF water temperature Twoff can be kept to a lower level.

Thus, as the vehicle indoor air temperature Tr becomes higher, the air conditioner for the vehicle of this embodiment can more effectively suppress the operation of the internal combustion engine EG for increasing the coolant temperature at the startup of the vehicle. When the required heating capacity is small, the operation of the internal combustion engine EG for increasing the coolant temperature at the startup of the vehicle can be suppressed more effectively.

In this embodiment, as mentioned in the description of control steps S1168, S1175, and S1176, when the seat air conditioner 90 serving as the auxiliary heating means is operating (when the seat heater is turned ON), the target upper limit water temperature is determined such that the engine OFF water temperature Twoff becomes lower at the startup of the vehicle as compared to when the seat air conditioner 90 is not operating (when the seat heater is turned OFF).

Thus, when the seat air conditioner 90 is operating, the air conditioner for the vehicle of this embodiment can suppress the operation of the internal combustion engine EG for increasing the coolant temperature at the startup of the vehicle. Further, when the seat air conditioner 90 is operating, the air conditioner for the vehicle can make the passenger feel sufficiently warm even though the temperature of air blown into the vehicle interior is low. Thus, the operation of the internal combustion engine EG that might increase the coolant temperature can be suppressed at startup without removing the warmth from the passenger.

In this embodiment, as mentioned in the description of control steps S1168, S1175, and S1176, the target upper limit water temperature is determined such that as the solar radiation amount Ts becomes larger, the engine OFF water temperature Twoff becomes lower at the startup of the vehicle.

That is, as the solar radiation amount Ts becomes larger, the air conditioner for the vehicle of this embodiment can more suppress the operation of the internal combustion engine EG for increasing the coolant temperature at the startup of the vehicle. When the required heating capacity is small, the operation of the internal combustion engine EG that might increase the coolant temperature can be suppressed effectively at the startup of the vehicle.

In this embodiment, as mentioned in the description of control steps S1168, S1175, and S1176, the target upper limit water temperature is determined such that as the interior preset temperature Tset becomes higher, the engine OFF water temperature Twoff becomes higher at the startup of the vehicle.

That is, as the vehicle interior preset temperature Tset becomes higher, the air conditioner for the vehicle of this embodiment can more suppress the operation of the internal combustion engine EG for increasing the coolant temperature at the startup of the vehicle. Thus, the air conditioner for the vehicle can exhibit its heating capacity according to the passenger's request at the startup, which can prevent the passenger from missing warmth.

In this embodiment, as mentioned in the description of control steps S1168, S1175, and S1176, when the economy switch serving as a power saving request means is turned on (ON) (in the eco mode), the target upper limit water temperature is determined such that the engine OFF water temperature Twoff becomes lower at the startup of the vehicle as compared to when the economy switch is not turned on (ON) (in states except for the eco mode).

In the eco mode requiring the power saving, the operation of the internal combustion engine EG for increasing the coolant temperature can be suppressed at the startup of the vehicle. Since the power saving is requested by the passenger, even though a heating capacity is slightly reduced by suppressing the operation of the engine EG, the air conditioner cannot make the passenger uncomfortable at all.

In this embodiment, as mentioned in the description of control steps S1164, and S1171, the initial target upper limit water temperature is determined to be equal to or more than the coolant temperature Tw directly after the startup of the vehicle. When the coolant temperature Tw directly after the startup of the vehicle is high, for example, when the vehicle is restarted shortly after the previous stopping, the engine OFF water temperature Twoff can become higher accordingly.

Thus, when the passenger felts insufficient warmth and the target vehicle interior temperature Tset is increased by operating the vehicle interior temperature setting switch, the coolant temperature Tw can be increased by quickly operating the internal combustion engine EG. Thus, the heating capacity of the air conditioner is exhibited according to the passenger's request, thereby providing the high warmth to the passenger.

### Seventh Embodiment

In the above sixth embodiment, the engine OFF water temperature Twoff increases at the startup of the vehicle as the time has elapsed. However, in a seventh embodiment, during the startup of the vehicle, the engine OFF water temperature Twoff increases with increasing vehicle interior temperature Tr.

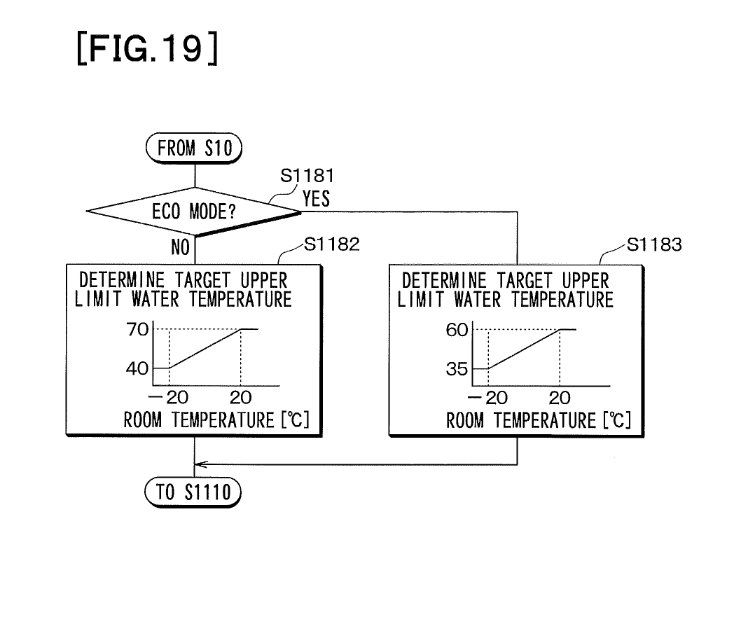

FIG. 19 shows the flowchart for explaining the details of the process of step S11 in this embodiment. In step S1181, first, it is determined whether or not the air conditioner is in the eco mode or not. When the air conditioner is determined not to be in the eco mode (if NO), the operation proceeds to step S1182, in which a target upper limit water temperature in other states except for the eco mode is determined based on the vehicle interior temperature Tr detected by the inside air sensor 51 with reference to the control map previously stored in the air conditioning controller 50, and then the operation proceeds to step S1110.

In this embodiment, specifically, as mentioned in the description of step S1182 of FIG. 19, as the vehicle interior temperature Tr (room temperature) becomes higher, the target upper limit water temperature is determined to be higher.

When the air conditioner is determined to be in the eco mode in step S1181 (if YES), the operation proceeds to step S1183, in which the target upper limit water temperature in the eco mode is determined based on the vehicle interior temperature Tr detected by the inside air sensor 51 with reference to the control map previously stored in the air conditioning controller 50. Then, the operation proceeds to step S1110.

In this embodiment, specifically, in step S1183 shown in FIG. 19, as the vehicle interior temperature Tr (room temperature) becomes higher, the target upper limit water temperature is determined to be higher. The target upper limit water temperature in the eco mode determined in step S1183 is determined to be lower than the target upper limit water temperature in other states except for the cco mode determined in step S1182.

In subsequent step S1110 and the following steps, the same processes as those of the sixth embodiment (see FIGS. 8 and 18) are performed.

This embodiment can make it difficult to output the engine ON request signal to the driving force controller 70 when the vehicle interior temperature Tr is low at startup in winter. Thus, the air conditioner of this embodiment can suppress the operation of the internal combustion engine EG that might increase the coolant temperature at the startup of the vehicle.

As the vehicle interior temperature Tr is increased, the engine ON request signal is more likely to be output to the driving force controller 70. Thus, this embodiment can improve the heating capacity with increasing interior temperature Tr to thereby make the passenger feel warmer.

In this embodiment, as mentioned in the description of control steps S1182 and S1183, when the economy switch serving as the power saving request means is turned on (ON) (in the eco mode), the target upper limit water temperature becomes low as compared to when the economy switch is not turned on (ON) (in other states except for the eco mode). As a result, when the economy switch is turned on (ON) (in the eco mode), the engine OFF water temperature Twoff at the startup of the vehicle becomes low as compared to when the economy switch is not turned on (ON) (in other states except for the eco mode).

In the eco mode requiring the power saving, the operation of the engine EG for increasing the coolant temperature can be suppressed at the startup of the vehicle. Since the power saving is requested by the passenger, even though a heating capacity is slightly reduced by suppression of the operation of the engine EG, the air conditioner cannot make the passenger uncomfortable at all.

### Other Embodiments

The present invention is not limited to the above embodiments, and various modifications and changes can be made to those embodiments without departing from the scope of the invention.

(1) The above respective embodiments may be appropriately combined. For example, the combination of the first and second embodiments may determine the engine ON request suppression time f(environment) based on the outside air temperature, the vehicle interior preset temperature, the remaining storage level SOC of the battery 81, the relative humidity of the vehicle interior air, the room temperature of a selected state in the eco mode, the solar radiation amount, and the operating state of the seat air conditioner 90.

The combination of the sixth and seventh embodiments may increase the engine OFF water temperature Twoff during the startup of the vehicle with increasing vehicle interior temperature Tr as the time has elapsed.

(2) In the above embodiments, the air conditioner 1 for the vehicle of the invention is applied to the plug-in hybrid car, but may be applied to a normal hybrid car.

(3) Although the above embodiments have not described the details of the driving force for traveling of the plug-in hybrid car, the air conditioner 1 for the vehicle of the invention may be applied to the so-called parallel type hybrid car which can travel by directly gaining the driving force from both the internal combustion engine EG and the electric motor for traveling.

The air conditioner 1 for the vehicle of the invention may be applied to the so-called serial hybrid car which uses the internal combustion engine EG as a driving source of a generator 80, stores the generated power in a battery 81, and then travels by obtaining the driving force from the electric motor for traveling operated by the power stored in the battery 81.

### REFERENCE SIGNS LIST

36 heater core (heating means)
50 air conditioning controller (air conditioning controlling means)
50a request signal output means
51 inside air sensor (vehicle-interior temperature detection means)
52 outside air temperature sensor (outside air temperature detection means)
53 solar radiation sensor (solar radiation amount detection means)
70 driving force controller (driving force control means)
90 seat air conditioner (auxiliary heating means)

1. An air conditioner for a vehicle which is applied to the vehicle having an electric motor for traveling and an internal combustion engine as driving sources for outputting a driving force for causing the vehicle to travel, the air conditioner comprising:
a heating section that heats blown air to be blown into a vehicle interior by using a coolant of the internal combustion engine as a heat source;
a request signal output section that outputs a request signal to a driving force control section in heating the vehicle interior, the driving force control section controlling an operation of the internal combustion engine, the request signal causing the internal combustion engine to operate until a temperature of the coolant reaches an upper limit temperature; and
a suppression section for suppressing output of the request signal from the request signal output section until a predetermined condition is satisfied after startup of the vehicle, wherein the predetermined condition is changed based on a remaining storage level of a battery.

2. The air conditioner for the vehicle according to claim 1, further comprising a time determination section for determining a predetermined time, wherein the predetermined condition includes a condition where the predetermined time has elapsed since the startup of the vehicle.

3. The air conditioner for the vehicle according to claim 2, further comprising a target temperature setting section that sets a target temperature of the vehicle interior based on an operation of a passenger,
wherein, as the target temperature becomes higher, the time determination section makes the predetermined time shorter.

4. The air conditioner for the vehicle according to claim 2, further comprising a power saving request section that outputs a power saving request signal based on an operation of the passenger, the power saving request signal being for requesting saving of power necessary for air conditioning of the vehicle interior,
wherein, when the power saving request signal is output, the time determination section makes the predetermined time longer as compared to when the power saving request signal is not output.

5. The air conditioner for the vehicle according to claim 2, further comprising an auxiliary heating section for increasing a temperature of at least a part of the vehicle interior,
wherein, when the auxiliary heating section operates, the time determination section makes the predetermined time longer as compared to when the auxiliary heating section does not operate.

6. The air conditioner for the vehicle according to claim 2, further comprising a vehicle-interior temperature detection section for detecting a temperature of the vehicle interior,
wherein, as the temperature of the vehicle interior becomes higher, the time determination section makes the predetermined time longer.

7. The air conditioner for the vehicle according to claim 2, further comprising a solar radiation amount detection section for detecting a solar radiation amount at the vehicle interior,
wherein, as the solar radiation amount becomes more, the time determination section makes the predetermined time longer.

8. The air conditioner for the vehicle according to claim 2, further comprising an outside air temperature detection section for detecting an outside air temperature,
wherein, as the outside air temperature becomes higher, the time determination section makes the predetermined time longer.

9. The air conditioner for the vehicle according to claim 2, further comprising a humidity detection section that detects a relative humidity of air in the vehicle interior,
wherein, as the relative humidity of the air in the vehicle interior becomes lower, the time determination section makes the predetermined time longer.

10. The air conditioner for the vehicle according to claim 2, wherein, as a remaining storage level of a battery becomes more, the time determination section makes the predetermined time longer.

11. The air conditioner for the vehicle according to claim 2, further comprising a time setting section that sets a time based on a passenger's operation,
wherein as the time set by the time setting section becomes longer, the time determination section makes the predetermined time longer.

12. The air conditioner for the vehicle according to claim 1, further comprising an upper limit temperature determination section for determining the upper limit temperature,
wherein until the predetermined condition is satisfied since startup of the vehicle, the upper limit temperature determination section lowers the upper limit temperature as compared to when or after the predetermined condition is satisfied.
